(19) United States
(12) Patent Application Publication
(10) Pub. No.: US 2025/0159698 A1
(43) Pub. Date: May 15, 2025

(54) METHOD PERFORMED BY USER EQUIPMENT, AND USER EQUIPMENT

(71) Applicant: SHARP KABUSHIKI KAISHA, Sakai City, Osaka (JP)

(72) Inventors: CHAO LUO, Shanghai (CN); Yinan Zhao, Shanghai (CN); RENMAO LIU, Shanghai (CN)

(21) Appl. No.: 18/726,267

(22) PCT Filed: Jan. 5, 2023
(86) PCT No.: PCT/CN2023/070676

§ 371 Date: Jul. 2, 2024

(30) Foreign Application Priority Data
Jan. 7, 2022 (CN) 202210019400.1

(51) Int. Cl. H04W 72/25; H04W 72/40

(52) U.S. Cl. CPC H04W 72/25; H04W 72/40

(57) ABSTRACT

Provided in the present invention are a method performed by user equipment, and user equipment. The method performed by user equipment includes: determining, according to sidelink control information (SCI) format 2-C, the content of SCI; and transmitting the SCI, wherein a field in the SCI indicates that the SCI is used to carry inter-UE coordination information, or indicates that the SCI is used to carry a coordination request, wherein the inter-UE coordination information is triggered by the UE according to a certain condition, or is a response to a coordination request transmitted by second user equipment (UE), and the coordination request is used to request inter-UE coordination information from third user equipment (UE).

### TECHNICAL FIELD

The present invention relates to a method performed by user equipment, and user equipment.

### BACKGROUND

Sidelink (SL) communication (e.g., when SL resource allocation mode 2 is configured) can support inter-user equipment (UE) coordination functions, e.g., coordination of resource allocation between two or more UEs. The inter-UE coordination functions need to solve a series of problems, for example, how to determine two or more UEs related to inter-UE coordination, and, for example, how to determine one or more messages related to inter-UE coordination and definitions, configurations, mapping, transmission, reception, etc., of resources respectively used thereby.

### PRIOR ART DOCUMENTS

### Non-Patent Documents

Non-Patent Document 1: RP-152293, New WI proposal: Support for V2V services based on LTE sidelink
Non-Patent Document 2: RP-170798, New WID on 3GPP V2X Phase 2
Non-Patent Document 3: RP-170855, New WID on New Radio Access Technology
Non-Patent Document 4: RP-190766, New WID on 5G V2X with NR sidelink
Non-Patent Document 5: RP-201385, WID revision: NR sidelink enhancement

### SUMMARY

In order to address at least part of the aforementioned issues, the present invention provides a method performed by user equipment, and user equipment. The value of a “first resource location” is flexibly indicated, so that a resource indication combination can efficiently indicate a resource in any slot in a corresponding coordination resource window.

According to the present invention, a method performed by user equipment is provided. The method is characterized by comprising: receiving first coordination information at a resource pool u; and determining a coordination resource set R on the resource pool u according to the first coordination information. The first coordination information comprises a starting slot t_{0,0}^{RIV} of a coordination resource window, M resource indication combinations RIC₁, . . . , and RIC_{M}, and reference slots t₁^{RIV,ref}, . . . , t_{M}^{RIV,ref} respectively corresponding to the M resource indication combinations. For m∈{1, . . . , M}, in the first coordination information, a slot in which each resource in the resource indication combination RICₘ is located is indicated as an offset thereof relative to a slot tₘ^{RIV,ref}, and the slot tₘ^{RIV,ref} f is indicated as an offset thereof relative to a slot t_{0,0}^{RIV}−1+(m−1)·G, where G is a predefined constant.

Furthermore, according to the present invention, provided is user equipment, comprising: a processor; and a memory, having instructions stored therein, wherein the instructions, when run by the processor, perform the above method.

Therefore, the present invention provides a method, in which the value of a “first resource location” is flexibly indicated, so that a resource indication combination can efficiently indicate a resource in any slot in a corresponding coordination resource window.

### BRIEF DESCRIPTION OF THE DRAWINGS

The above and other features of the present invention will be more apparent from the following detailed description in combination with the accompanying drawings, in which:

FIG. 1 shows a method for determining, according to a time resource indicator value (TRIV or Time RIV), the number (N) of indicated resources, an offset (t₁) of a slot in which a second resource is located relative to a slot in which a first resource is located, and an offset (t₂) of a slot in which a third resource is located relative to the slot in which the first resource is located.

FIG. 2 shows a method for determining, according to a frequency resource indicator value (FRIV or Frequency RIV), a starting sub-channel (n_{subCH,1}^{start}) of a second resource, a starting sub-channel (n_{subCH,2}^{start}) of a third resource, and the number (L_{subCH}) of consecutive sub-channels corresponding to each resource.

FIG. 3 shows a flowchart corresponding to a method performed by user equipment according to Embodiment 1 of the present invention.

FIG. 4 shows an example of a first resource indication combination (RIC, or referred to as resource combination) control element type.

FIG. 5 shows an example of a second RIC control element type.

FIG. 6 shows an example of a third RIC control element type.

FIG. 7 shows an example of a fourth RIC control element type.

FIG. 8 shows an example of a fifth RIC control element type.

FIG. 9 shows a block diagram of user equipment (UE) to which the present invention relates.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

In the following description, a 5G (or referred to as “New Radio” (NR) or 5G NR) mobile communication system and later evolved versions thereof (e.g., 5G Advanced) are used as exemplary application environments to specifically describe a plurality of embodiments according to the present invention. However, it is to be noted that the present invention is not limited to the following embodiments, but is applicable to many other wireless communication systems, such as a communication system after 5G and a 4G mobile communication system before 5G.

The terms given in the present invention may vary in Long Term Evolution (LTE), LTE-Advanced, LTE-Advanced Pro, NR, and subsequent communication systems, but unified terms are used in the present invention. When applied to a specific system, the terms can be replaced with terms used in the corresponding system.

Unless otherwise specified, in all embodiments and implementations of the present invention where applicable:
Optionally, an eNB may refer to a 4G base station. For example, the eNB may provide termination of Evolved UMTS Terrestrial Radio Access (E-UTRA) user plane and control plane protocols to the UE. As another example, the eNB may be connected to an Evolved Packet Core (EPC) by means of an Si interface.
Optionally, an ng-eNB may refer to an enhanced 4G base station. For example, the ng-eNB may provide termination of E-UTRA user plane and control plane protocols to the UE. As another example, the ng-eNB may be connected to a 5G core network (5GC) by means of an NG interface.
Optionally, a gNB may refer to a 5G base station. For example, the gNB may provide termination of NR user plane and control plane protocols to the UE. As another example, the gNB may be connected to a 5GC by means of an NG interface.
Optionally, μ represents a subcarrier spacing configuration (or an SCS configuration), e.g., a subcarrier spacing configuration configured in a resource grid, or a subcarrier spacing configuration configured in a carrier, or a subcarrier spacing configuration configured in a bandwidth part (BWP) (e.g., an uplink (UL) BWP, or a downlink (DL) BWP, or an SL BWP), or a subcarrier spacing configuration corresponding to a link (e.g., a UL, a DL, or an SL). A subcarrier spacing (SCS) corresponding to μ may be denoted as Δf, e.g., Δf=2^{μ}·15 kHz.
Optionally, “{a₁, . . . , a_{N}}” may represent an ordered set arranged in ascending order of values of elements in the set or indexes of elements in the set, where if a_{N}<a₁, then “{a₁, . . . , a_{N}}” may represent an empty set Ø. For example, {1, . . . , 3} may represent {1, 2, 3}. As another example, {1, . . . , 1} may represent {1}. As another example, {1, . . . , 0} may represent Ø.
Optionally, “symbol” may refer to an orthogonal frequency division multiplexing (OFDM) symbol.
Optionally, “length” and “size” are interchangeable. For example, the “size” of a field in a downlink control information (DCI) format may be referred to as the “length” of the field.
Optionally, “starting” and “lowest” are interchangeable. For example, the “lowest subcarrier” of a carrier may be referred to as the “starting subcarrier” of the carrier.
Optionally, “starting” and “first” are interchangeable. For example, the “first symbol” of a slot may be referred to as the “starting symbol” of the slot.
Optionally, “ending” and “highest” are interchangeable. For example, the “highest subcarrier” of a carrier may be referred to as the “ending subcarrier” of the carrier.
Optionally, “ending” and “last” are interchangeable. For example, the “last symbol” of a slot may be referred to as the “ending symbol” of the slot.
Optionally, “number” and “index” are interchangeable. For example, twelve subcarriers in one resource block may be respectively numbered (or indexed) as subcarrier 0, subcarrier 1, . . . , and subcarrier 11 in ascending order of frequencies. Accordingly, the numbers (or indexes) of these subcarriers are respectively 0, 1, . . . and 11.
Optionally, one “resource” may correspond to one or more of the following:
   One or more parameters in the time domain. For example, a starting symbol of the resource. As another example, a starting slot of the resource. As another example, the number of symbols occupied by the resource. As another example, the number of slots occupied by the resource.
   One or more parameters in the frequency domain. For example, a starting sub-channel of the resource. As another example, a starting resource block of the resource. As another example, a starting subcarrier of the resource. As another example, the number of sub-channels occupied by the resource. As another example, the number of resource blocks occupied by the resource. As another example, the number of subcarriers occupied by the resource.
   One or more parameters in the code domain. For example, a cyclic shift corresponding to the resource or a corresponding cyclic shift index. As another example, a cyclic shift pair corresponding to the resource or a corresponding cyclic shift pair index.
   One or more parameters in the spatial domain. For example, a multiple input multiple output (MIMO) layer corresponding to the resource.
Optionally, the notation of a time-domain (or frequency-domain, or code-domain, or spatial-domain) resource may be used to represent an index of the resource in the time domain (or the frequency domain, or the code domain, or the spatial domain). For example, if a slot is denoted as t₁, then t₁=0 may indicate that an index of the slot (e.g., an index of the slot in a corresponding subframe) is 0. As another example, if a sub-channel is denoted as f₁, then f₁=0 may indicate that an index of the sub-channel (e.g., an index of the sub-channel in a corresponding resource pool) is 0.
Optionally, any two among “within X”, “in X”, and “on X” are interchangeable. X may be one or more carriers, or one or more BWPs, or one or more resource pools, or one or more links (e.g., a UL, a DL, or an SL), or one or more channels, or one or more sub-channels, or one or more resource block groups (RBGs), or one or more resource blocks (RBs), or one or more “occasions” (e.g., a physical downlink control channel (PDCCH) monitoring occasion, a physical sidelink shared channel (PSSCH) transmission occasion, a PSSCH reception occasion, a physical sidelink feedback channel (PSFCH) monitoring occasion, a PSFCH transmission occasion, a PSFCH reception occasion, a physical sidelink control channel (PSCCH) monitoring occasion, a PSCCH transmission occasion, a PSCCH reception occasion, or the like), or one or more symbols, or one or more slots, or one or more subframes, or one or more half-frames, or one or more frames, or one or more other time-domain and/or frequency-domain and/or code-domain and/or spatial-domain resources, etc.
Optionally, “higher layer(s)” or “upper layer(s)” may refer to one or more protocol layers or protocol sub-layers above a reference protocol layer (or a reference protocol sub-layer) in a protocol stack. For example, if the reference protocol layer is a physical layer, then the “higher layer” may refer to a medium access control (MAC) layer, a radio link control (RLC) layer, a packet data convergence protocol (PDCP) layer, a radio resource control (RRC) layer, a PC5-S layer, a PC5 RRC layer, a vehicle-to-everything (V2X) layer, an application layer, a V2X application layer, or the like. Optionally, unless otherwise specified, the reference protocol layer (or the reference protocol sub-layer) may refer to the physical layer.
Optionally, “lower layer(s)” may refer to one or more protocol layers or protocol sub-layers below a reference protocol layer (or a reference protocol sub-layer) in a protocol stack. For example, if the reference protocol layer is the MAC layer, then the “lower layer” may refer to the physical layer. Optionally, unless otherwise specified, the reference protocol layer (or the reference protocol sub-layer) may refer to the RRC layer, the PC5 RRC layer, or the MAC layer.
Optionally, a “predefined” value may be a value related to a subcarrier spacing. For example, different subcarrier spacings each correspond to a predefined constant. Specifically, for example, for μ=0, 1, 2, and 3, the predefined values are respectively 3, 5, 9, and 17.
Optionally, “pre-configure” may represent pre-configuration performed in a higher layer (e.g., an RRC layer) protocol, such as pre-configured (for example, pre-configured according to the specification of the higher layer protocol) in a specific storage location in the UE, or pre-configured (for example, pre-configured according to the specification of the higher layer protocol) in a specific storage location that can be accessed by the UE.
Optionally, “configure” may represent configuration performed in a higher-layer protocol by means of signaling. For example, configuration is performed for the UE by means of RRC signaling transmitted from the base station to the UE. As another example, configuration is performed for UE-2 by means of PC5 RRC signaling transmitted from UE-1 to UE-2.
Optionally, any two among “configure”, “indicate”, and “provide” are interchangeable, and any two among “configured by . . . ”, “indicated by . . . ”, and “provided by . . . ” are interchangeable.
Optionally, “configure” and “signal” are interchangeable.
Optionally, Δ(x₁, x₂) represents an offset between x₁ and x₂, or may be referred to as an offset of x₂ with respect to x₁, or an offset of x₂ relative to x₁, or an offset from x₁ to x₂, where x₁ and x₂ may be two parameters that can be compared, or two values of one parameter (e.g., two slots, two subframes, two half-frames, two frames, two subcarriers, two resource blocks, two resource block groups, two sub-channel, or the like). For example, in a set Aₛₑₜ^{ref}={a₁^{ref}, . . . , a_{N}_{ₛₑₜ}_{^{ref}}^{ref}}, if x₁=aᵢ^{ref} (1≤i≤Nₛₑₜ^{ref}) and x₂=aⱼ^{ref} (1≤j≤Nₛₑₜ^{ref}), then Δ(x₁, x₂) may be defined as j−i, or defined as aⱼ^{ref}−aᵢ^{ref}. Optionally, if Δ(x₁, x₂)>0, then x₁ is less (or lower, or earlier) than x₂. Optionally, if Δ(x₁, x₂)<0, then x₁ is greater (or higher, or later) than x₂. Optionally, if Δ(x₁, x₂)=0, then x₁ is equal to x₂.
Optionally, a time-domain resource may be referred to as a time resource, and vice versa.
Optionally, time-domain resource numbers (e.g., in chronological order) may start from 0 or 1. For example, for 30 kHz SCS, a set of slots in a subframe may be represented by a set of corresponding slot numbers as {0, 1} or {1, 2}.
Optionally, a frame may be a system frame, and a corresponding frame number may be referred to as a system frame number (SFN). System frames corresponding to the same SFN may occur periodically, for example, in a period of 1024 frames, and correspondingly, SFNs in one system frame period may respectively be 0, 1, . . . , 1023. The duration of one system frame may be 10 milliseconds, and correspondingly the duration of one system frame period may be 10240 milliseconds.
Optionally, a frame may be a direct frame, and a corresponding frame number may be referred to as a direct frame number (DFN). Direct frames corresponding to the same DFN may occur periodically, for example, in a period of 1024 frames, and correspondingly, DFNs in a direct frame period may respectively be 0, 1, . . . , 1023. The duration of one direct frame may be 10 milliseconds, and correspondingly the duration of one direct frame period may be 10240 milliseconds.
Optionally, the number of a slot may be the number of the slot in a corresponding subframe. For example, a set of corresponding slot numbers is {0, 1, . . . , Nₛₗₒₜ^{subframe,μ}−1}, where Nₛₗₒₜ^{subframe,μ} is the number of slots in one subframe. Nₛₗₒₜ^{subframe,μ} may be related to μ, for example Nₛₗₒₜ^{subframe,μ}=2^{μ}.
Optionally, the number of a slot may be the number of the slot in a corresponding half-frame. For example, a set of corresponding slot numbers is {0, 1, . . . , Nₛₗₒₜ^{halfframe,μ}−1} where Nₛₗₒₜ^{halfframe,μ} is the number of slots in one half-frame. Nₛₗₒₜ^{halfframe,μ} may be related to ρ, for example Nₛₗₒₜ^{halfframe,μ}=5·2^{μ}.
Optionally, the number of a slot may be the number of the slot in a corresponding frame (e.g., a system frame or a direct frame). For example, a set of corresponding slot numbers is {0, 1, . . . , Nₛₗₒₜ^{frame,μ}−1}, where Nₛₗₒₜ^{frame,μ} is the number of slots in one frame. Nₛₗₒₜ^{frame,μ} may be related to μ, for example Nₛₗₒₜ^{frame,μ}=10·2^{μ}.
Optionally, the number of a slot may be the number of the slot in a corresponding frame period (e.g., a system frame period or a direct frame period). For example, a set of corresponding slot numbers is {0, 1, . . . , Nₛₗₒₜ^{frameperiod,μ}−1}, where Nₛₗₒₜ^{frameperiod,μ} is the number of slots in one frame period. Nₛₗₒₜ^{frameperiod,μ} may be related to μ, for example Nₛₗₒₜ^{frameperiod,μ}=10240×2^{μ}.
Optionally, a set of all slots in a predefined or configured or pre-configured time (e.g., one subframe, or one half-frame, or one frame, or one frame period) may be referred to as a “physical slot set”, wherein each slot may be referred to as a “physical slot”, and a corresponding slot number may be referred to as a “physical slot number”. For example, in one frame period, the physical slot set may be denoted as Tₐₗₗ^{phy}={t₀^{phy}, t₁^{phy}, . . . , t_{10240×2}_{^{μ}}₋₁^{phy}}, for example, t₀^{phy}=0, t₁^{phy}=1, . . . , t_{10240×2}_{^{μ}}₋₁^{phy}=10240×2^{μ}−1.
Optionally, a frequency-domain resource may also be referred to as a frequency resource.
Optionally, a resource block may refer to a Virtual Resource Block (VRB), or a Physical Resource Block (PRB), or a Common Resource Block (CRB), or a resource block defined in another manner.
Optionally, frequency-domain resource numbers (e.g., in ascending order of the frequency) may start from 0 or 1. For example, if the number of sub-channels (or subchannels) configured in a resource pool ρ is N_{subChannel}^{SL,u}, then a set of sub-channels in the resource pool may be represented by a set of corresponding sub-channel numbers as {0, 1, . . . , N_{subChannel}^{SL,u}−1} or as {1, 2, . . . , N_{subChannel}^{SL,u}}. As another example, a set of subcarriers in one resource block may be represented by a set of corresponding subcarrier numbers as {0, 1, . . . , 11} or {1, 2, . . . , 12}.
Optionally, an offset between two subcarriers may refer to an offset between center frequencies of the two subcarriers, and is represented by, for example, the number of subcarriers or the number of resource blocks.
Optionally, an offset between two resource blocks may refer to an offset between center frequencies of the lowest numbered subcarriers of the two resource blocks, and is represented by, for example, the number of resource blocks or the number of subcarriers.
Optionally, “SCI” (sidelink control information) may refer to an SCI transmission (or an SCI reception). The SCI transmission (or the SCI reception) corresponds to an SCI format (e.g., a 1^{st}-stage SCI format or a 2^{nd}-stage SCI format), or an SCI format combination (e.g., a 1^{st}-stage SCI format and a corresponding 2^{nd}-stage SCI format).
Optionally, an “SL transmission” may include one or more of the following:
   A PSSCH transmission.
   A PSCCH transmission and a corresponding (or associated) PSSCH transmission thereof.
   A PSCCH transmission or a corresponding (or associated) PSSCH transmission thereof.
   A PSFCH transmission.
   A sidelink-synchronization signal/physical sidelink broadcast channel (S-SS/PSBCH, or referred to as S-SSB) transmission.
Optionally, an “SL resource” is a resource that can be used for SL transmission and/or SL reception.
Optionally, “resource pool” may be replaced with “SL resource pool”.
Optionally, in a predefined or configured or pre-configured time (e.g., one subframe, or one half-frame, or one frame, or one frame period), a set formed by all slots that may belong to the same resource pool is referred to as an “SL slot set”, wherein each element thereamong may correspond to one “SL slot”, and a corresponding index may be referred to as an “SL slot index”. For example, in a frame period (e.g., a system frame period or a direct frame period), the SL slot set may be denoted as Tₐₗₗ^{SL}={t₀^{SL}, t₁^{SL}, . . . , t_{T}_{ₘₐₓ}₋₁^{SL}}, where Tₘₐₓ is the number of elements in the SL slot set Tₐₗₗ^{SL}. Optionally, physical slots respectively corresponding to two adjacent SL slots (e.g., the slot t₀^{SL} and the slot t₁^{SL}) in the SL slot set Tₐₗₗ^{SL} may be adjacent to each other, or may not be adjacent to each other. Optionally, the set Tₐₗₗ^{SL} may be a set of slots that remain after slots in the following sets are excluded from the physical slot set Tₐₗₗ^{phy}.
   A set formed by S-SSB slots (e.g., the number of slots in the set is denoted as N_{S_SSB}). An S-SSB slot may be a slot in which an S-SSB is configured.
A set formed by non-SL slots (e.g., the number of slots in the set is denoted as N_{nonSL}). A non-SL slot may be a slot in which at least one among consecutive N_{length}^{SL} symbols starting from a symbol lₛₜₐᵣₜ^{SL} is not configured to be a UL symbol, where lₛₜₐᵣₜ^{SL} represents a starting symbol (e.g., configured by a parameter sl-StartSymbol) for SL in a slot (e.g., a non-S-SSB slot), and N_{length}^{SL} represents the number (e.g., configured by a parameter sl-LengthSymbols) of symbols for SL in a slot (e.g., a non-S-SSB slot). Optionally, a non-SL slot is always a slot in which no S-SSB is configured.
   A set formed by reserved slots (e.g., the number of slots in the set is denoted as N_{reserved}, where N_{reserved}=(10240×2^{μ}−N_{S_SSB}−N_{nonSL}) mod L_{bitmap}, where L_{bitmap} may be the length of a bitmap configured by a higher layer). If slots that remain after the slots in the S-SSB slot set and the slots in the non-SL slot set are excluded from the physical slot set Tₐₗₗ^{phy} are respectively denoted as l₀, l₁, . . . , l_{(10240×2}_{^{μ}}_{N}_{_{S,SSB}}_{-N}_{_{nonSL}}₋₁₎ in ascending order of slot indexes, and if, for 0≤r<10240×2^{μ}−N_{S_SSB}−N_{nonSL}, r satisfies r=└m·(10240×2^{μ}−N_{S_SSB}−N_{nonSL)}/N_{reserved}┘, m=0, 1, . . . , N_{reserved}−1, then the slot lᵣ belongs to the reserved slot set.
Optionally, in a predefined or configured or pre-configured time (e.g., one subframe, or one half-frame, or one frame, or one frame period), a set of all slots in the resource pool u may be referred to as a “logical slot set”, wherein each slot may be referred to as a “logical slot”, and a corresponding slot number may be referred to as a “logical slot number”. For example, in one frame period (e.g., a system frame period or a direct frame period), the logical slot set may be denoted as Tᵤ^{SL}={t′₀^{SL,u}, t′₁^{SL,u}, . . . , t′_{T′}_{ₘₐₓ}_{^{u}}₋₁^{SL,u}} where T′ₘₐₓ^{u} is the number of elements in the logical slot set Tᵤ^{SL}. Optionally, SL slots (or physical slots) respectively corresponding to two adjacent logical slots (e.g., the slot t′₀^{SL,u} and the slot t′₁^{SL,u}) in the logical slot set Tᵤ^{SL} may be adjacent to each other, or may not be adjacent to each other.
Optionally, for a slot t₁ and a slot t₂, Δ(t₁, t₂) may refer to an offset between physical slots respectively corresponding to the slot t₁ and the slot t₂ (e.g., representing the number of milliseconds or the number of physical slots in a corresponding time interval), or an offset between SL slots respectively corresponding to the slot t₁ and the slot t₂, or an offset between logical slots respectively corresponding to the slot t₁ and the slot t₂.
Optionally, for a slot t₁ and a slot t₂, if Δ(t₁, t₂)=D, then the slot t₂ may be denoted as t₂=NEXT (t₁, D).
Optionally, for a slot t₁ and a slot t₂, if Δ(t₁, t₂)=D, then the slot t₁ may be denoted as t₁=PREV (t₂, D).
Optionally, a time window (or referred to as a “time interval”, and, for example, denoted as W) corresponds to a starting slot (e.g., denoted as tₛₜₐᵣₜ^{W}), an ending slot (e.g., denoted as t_{end}^{W}), and a size (or referred to as length, and, for example, denoted as LEN(W)). LEN(W) may be equal to Δ(tₛₜₐᵣₜ^{W}, t_{end}^{W}), or equal to Δ(NEXT(tₛₜₐᵣₜ^{W},1),t_{end}^{W}), or equal to Δ(PREV(tₛₜₐᵣₜ^{W},1),t_{end}^{W}), or equal to Δ(tₛₜₐᵣₜ^{W},NEXT(t_{end}^{W},1)), or equal to Δ(NEXT(tₛₜₐᵣₜ^{W},1),NEXT(t_{end}^{W},1)), or equal to Δ(PREV(tₛₜₐᵣₜ^{W},1),NEXT(t_{end}^{W},1)), or equal to Δ(tₛₜₐᵣₜ^{W},PREV(t_{end}^{W},1)), or equal to Δ(NEXT(tₛₜₐᵣₜ^{W},1),PREV(t_{end}^{W},1)), or equal to Δ(PREV(tₛₜₐᵣₜ^{W},1),PREV(t_{end}^{W},1)).

Resource allocation modes related to SL operations may include:
Mode 1 (or Resource Allocation Mode 1, or Sidelink Resource Allocation Mode 1): a base station schedules a resource for SL transmission.
Mode 2 (or Resource Allocation Mode 2, or Sidelink Resource Allocation Mode 2): a UE determines a resource for SL transmission (i.e., the base station does not participate in scheduling of resources for SL transmission). For example, a UE performing an SL transmission operation autonomously determines a resource for SL transmission.

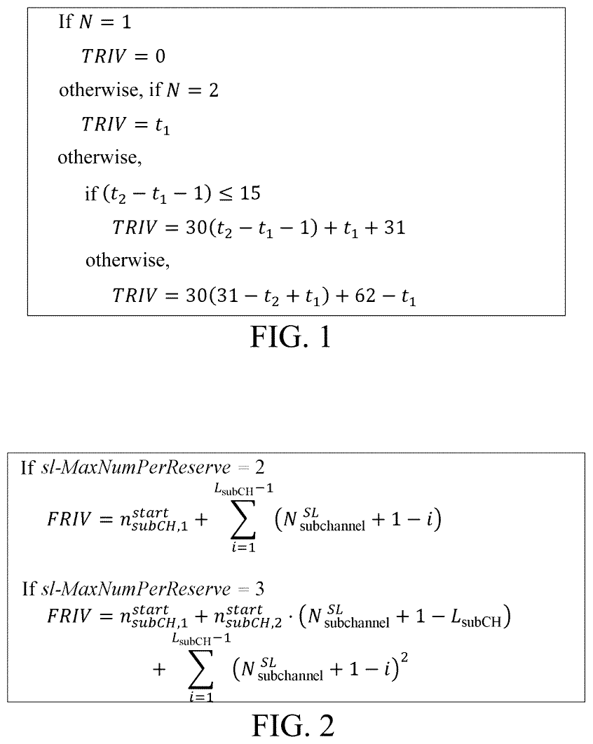

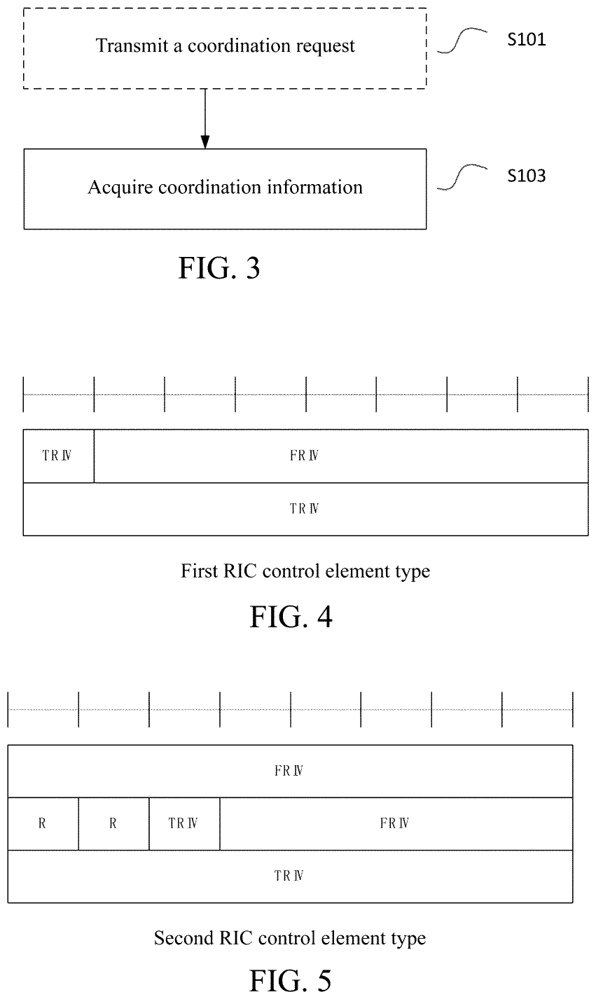

A PSCCH transmission and a “time resource assignment” field and a “frequency resource assignment” field in SCI (e.g., SCI format 1-A) included therein may be used to determine N resources that are associated with the SCI and may be used for SL transmission (e.g., PSCCH and/or PSSCH transmission), wherein the value range of N may be determined by one or more predefined or configured or pre-configured parameters (e.g., N≥1, and e.g., N≤N_{MAX}, where Nu may be configured or pre-configured by a higher layer parameter (e.g., sl-MaxNumPerReserve), and specifically, e.g., if N_{MAX}=2, then N∈{1, 2}, and e.g., if N_{MAX}=3, then N∈{1, 2, 3}). The N resources may be respectively referred to as a “first resource”, . . . , and an “N-th resource” in chronological order. A slot (e.g., denoted as t₀^{SL,RES}) in which the first resource is located may be a slot in which the PSCCH transmission is located (or referred to as a “slot in which the SCI is located” or a “slot in which the SCI is received”), and a slot in which each of other resources is located may be expressed as a slot offset thereof relative to the slot t₀^{SL,RES} For example, the slot (e.g., denoted as t₁^{SL,RES}) in which the second resource is located may be expressed as t₁=Δ(t₀^{SL,RES},t₁^{SL,RES}), and the slot (e.g., denoted as t₂^{SL,RES}) in which the third resource is located may be expressed as t₂=Δ(t₀^{SL,RES}t₂^{SL,RES}). N, t₁ (e.g., when N=2 or N=3), and t₂ (e.g., when N=3) may be determined according to a TRIV indicated in the “time resource assignment” field in the SCI, such as in the manner shown in FIG. 1.

In the frequency domain, the N resources correspond to the same number of sub-channels (e.g., denoted as L_{subCH}, e.g., representing L_{subCH} consecutively allocated sub-channels). In the N resources, a starting sub-channel (i.e., a starting sub-channel of a corresponding SL transmission, and, for example, denoted as n_{subCH,0}^{start}) of the first resource is a sub-channel in which a starting resource block of the PSCCH transmission is located, and starting sub-channels of the other resources (e.g., starting sub-channels of the second resource and the third resource are respectively denoted as n_{subCH,1}^{start} and n_{subCH,2}^{start}) and L_{subCH} may be determined according to a FRIV indicated by the “frequency resource assignment” field in the SCI, such as in the manner shown in FIG. 2. If N<N_{MAX}, then sub-channels corresponding to the last N_{MAX}−N resources indicated by the FRIV are not used.

The above-described procedure of determining the time- and frequency-domain parameters of the N resources may be referred to as an “SL resource reservation procedure”.

SL communication (e.g., in SL resource allocation mode 2) can support inter-UE coordination (or simply referred to as “coordination”) functions, e.g., coordination of resource allocation and/or reservation and/or indication and/or use between two or more UEs, so as to improve the efficiency of resource allocation and/or reservation and/or indication and/or use, and/or reduce conflicts in resource allocation and/or reservation and/or indication and/or use, and/or alleviate and/or eliminate interference, etc. Specifically, for example, a UE (e.g., referred to as UE-A) may respectively transmit “inter-UE coordination information” (or referred to as “coordination information”) to one or more other UEs (e.g., referred to as UE-B if only one other UE is present, or respectively referred to as UE-B1, UE-B2, . . . if more than one other UE is present). The coordination information may explicitly or implicitly indicate (or correspond to, or be associated with) one or more resource sets (e.g., each such resource set is referred to as a “coordination resource set”, and correspondingly, each resource in a coordination resource set is referred to as a “coordination resource”).

Optionally, one UE may support one or more coordination schemes. Different coordination schemes may correspond to different coordination information determination methods, and/or coordination information contents (e.g., the content of a corresponding coordination resource set), and/or coordination information transmission triggering conditions and/or methods, and/or coordination information transmission methods, etc.

Optionally, in a first coordination scheme, resources in a coordination resource set may be “preferred resources”. Correspondingly, the coordination resource set may be referred to as “a set of preferred resources”, and coordination information including a “set of preferred resources” may be referred to as “preferred co-ordination information” (or referred to as “preferred inter-UE co-ordination information”). A preferred resource indicated by UE-A to UE-B may be a resource that UE-A wants UE-B to use (or to use preferentially), for example, when performing SL transmission the destination of which is UE-A. Upon receiving the set of preferred resources, UE-B may perform resource selection or resource reselection on the basis of one or more resource sets. The one or more resource sets may include the coordination resource set (e.g., referred to as a set S_{RES}^{CO}) and/or a resource set (e.g., referred to as a set S_{SNS}) identified by UE-B on the basis of a sensing result thereof. Specifically, for example, if the number of resources in an intersection between the set S_{RES}^{CO} and the set S_{SNS} is greater than (or, greater than or equal to) a certain threshold, then UE-B performs resource selection or resource reselection on the basis of the intersection between the set S_{RES}^{CO} and the set S_{SNS}.

Optionally, in the first coordination scheme, resources in a coordination resource set may be “non-preferred resources”. Correspondingly, the coordination resource set may be referred to as “a set of non-preferred resources”, and coordination information including a “set of non-preferred resources” may be referred to as “non-preferred co-ordination information” (or referred to as “non-preferred inter-UE co-ordination information”). A non-preferred resource indicated by UE-A to UE-B may be a resource that UE-A wants UE-B to avoid using (or preferentially not to use, or to exclude preferentially), for example, when performing SL transmission the destination UE of which is UE-A. Upon receiving the coordination resource set, UE-B may perform resource selection or resource reselection on the basis of one or more resource sets. The one or more resource sets may include the set of non-preferred resources (e.g., referred to as a set S_{RES}^{CO}) and/or a resource set S_{SNS} identified by UE-B on the basis of a sensing result thereof. Specifically, for example, UE-B may, when performing resource selection or resource reselection (e.g., when performing resource selection or resource reselection on the basis of the set S_{SNS}), exclude resources overlapping with resources in the set S_{RES}^{CO}.

Optionally, transmission of coordination information may be triggered according to one or more predefined or configured or pre-configured conditions by a UE transmitting the coordination information. For example, the condition that UE-A transmits the coordination information to UE-B may include UE-A performing resource selection (or reselection) for a transport block the destination UE of which is UE-B.

Optionally, the coordination information may be a response to or triggered by a “coordination request” (or referred to as an “explicit coordination request” or an “explicit request”). For example, UE-B transmits a coordination request to UE-A to request a coordination resource set (for example, requesting a set of preferred resources or a set of non-preferred resources). In response to the coordination request, UE-A may determine a corresponding coordination resource set, and indicate the coordination resource set in coordination information transmitted to UE-B.

Optionally, part or all of the coordination information may be included in SL control information. The SL control information may be physical layer control information, or higher layer control information. For example, part or all of the coordination information may be included in 1^{st}-stage SCI. As another example, part or all of the coordination information may be included in 2^{nd}-stage SCI. As another example, part or all of the coordination information may be included in sidelink feedback control information (SFCI). As another example, part or all of the coordination information may be included in other SL control information (e.g., referred to as sidelink coordination control information (SCCI)).

Optionally, part or all of the coordination information may be included in higher layer (e.g., the MAC layer, or the RRC layer) signaling. For example, part or all of the coordination information may be included in a MAC Control Element (MAC CE). As another example, part or all of the coordination information may be included in an RRC message.

Optionally, part or all of the information in the coordination request may be included in SL control information. The SL control information may be physical layer control information, or higher layer control information. For example, part or all of the information in the coordination request may be included in 1^{st}-stage SCI. As another example, part or all of the information in the coordination request may be included in 2^{nd}-stage SCI. As another example, part or all of the information in the coordination request may be included in SFCI. As another example, part or all of the information in the coordination request may be included in other SL control information (e.g., in SCCI).

Optionally, part or all of the information in the coordination request may be included in one higher layer (e.g., the MAC layer, or the RRC layer) signaling. For example, part or all of the information in the coordination request may be included in a MAC CE. As another example, part or all of the information in the coordination request may be included in an RRC message.

Optionally, the first coordination scheme may be configured or pre-configured or indicated as enabled or disabled. Optionally, whether the first coordination scheme is enabled (or disabled) may be configured or pre-configured or indicated separately for each resource pool. Optionally, methods for enabling (or disabling) the first coordination scheme may include a semi-persistent method (e.g., configured or pre-configured by means of a higher-layer protocol) and/or a dynamic method (e.g., indicated in SCI). Optionally, enabling the first coordination scheme means enabling transmission and/or reception of a coordination request, and/or transmission and/or reception of coordination information.

### Embodiment 1

A method performed by user equipment according to Embodiment 1 of the present invention will be described below with reference to FIG. 1.

FIG. 1 shows a flowchart corresponding to the method performed by user equipment according to Embodiment 1 of the present invention.

As shown in FIG. 1, in Embodiment 1 of the present invention, steps performed by user equipment (UE, for example, referred to as UE-B) include: step S101 and step S103.

Specifically, optionally, in step S101, a first coordination request is transmitted. For example, the first coordination request is transmitted on a resource pool u_{CR}.

Optionally, the first coordination request is used to request coordination information (e.g., a coordination resource set, and/or other coordination information) from another UE (e.g., denoted as UE-A).

Optionally, part of the information included in the first coordination request is referred to as a first part of the first coordination request, and the remaining information is referred to as a second part of the first coordination request.

Optionally, the first coordination request corresponds to a source layer-2 identifier (e.g., referred to as a “first source layer-2 identifier”) and a destination layer-2 identifier (e.g., referred to as a “first destination layer-2 identifier”). The first source layer-2 identifier may be used to identify UE-B, and the first destination layer-2 identifier may be used to identify UE-A.

Optionally, the first coordination request is carried in an SL transmission (e.g., for i∈{1, . . . , N_{CR}}, the SL transmission is denoted as Trᵢ^{CR}) in one or more slots (e.g., respectively denoted as t₁^{CR}, . . . , t_{N}_{_{CR}}^{CR} in chronological order). The SL transmission Tr₁^{CR} may be referred to as an “initial transmission” of the first coordination request, and an SL transmission Trᵢ^{CR} (1<i≤<N_{CR}, if applicable) may be referred to as a “re-transmission” of the first coordination request. N_{CR} may be a predefined or configured or pre-configured value (e.g., N_{CR}=1), or may be determined by one or more predefined or configured or pre-configured parameters, or may be autonomously determined by UE-B, or may be determined in another manner.

Optionally, for i∈{1, . . . , N_{CR}}, j∈{1, . . . , N_{CR}}, and i≠j, information in the first coordination request carried in the SL transmission Trᵢ^{CR} and information in the first coordination request carried in the SL transmission Trⱼ^{CR} may be completely the same or partially the same. For example, if a future slot t_{X}^{CR,I} is indicated in the first coordination request as an offset relative to a slot in which the SL transmission carrying the SL request is located, then the first coordination request carried in the SL transmission Trᵢ^{CR} and the first coordination request carried in the SL transmission Trⱼ^{CR} respectively indicate Δ(tᵢ^{CR},t_{X}^{CR,IJ}) and Δ(tⱼ^{CR},t_{X}^{CR,I})) and Δ(tᵢ^{CR},t_{X}^{CR,I})≠Δ(tⱼ^{CR},t_{X}^{CR,I}).

Optionally, the SL transmissions Tr₁^{CR}, . . . Tr_{N}_{_{CR}}^{CR} R are associated with the same cast type, e.g., unicast.

Optionally, the SL transmissions Tr₁^{CR}, . . . , Tr_{N}_{_{CR}}^{CR} are associated with the same 1^{st}-stage SCI format (e.g., referred to as a first SCI format).

Optionally, for i∈{1, . . . , N_{CR}}, j∈{1, . . . , N_{CR}}, and i≠j, the SL transmission Trᵢ^{CR} and the SL transmission Trⱼ^{CR} may be associated with the same 1^{st}-stage SCI format, or may be associated with different 1^{st}-stage SCI formats.

Optionally, the SL transmissions Trᵢ^{CR}, . . . , Tr_{N}_{_{CR}}^{CR} are associated with the same 2^{nd}-stage SCI format (e.g., referred to as a second SCI format).

Optionally, for i∈{1, . . . , N_{CR}}, j∈{1, . . . , N_{CR}}, and i≠j, the SL transmission Trᵢ^{CR} and the SL transmission Trⱼ^{CR} may be associated with the same 2^{nd}-stage SCI format, or may be associated with different 2^{nd}-stage SCI formats.

Optionally, for i∈{1, . . . , N_{CR}}, the 1^{st}-stage SCI format associated with the SL transmission Trᵢ^{CR} does not include any information in the first coordination request.

Optionally, for i∈{1, . . . , N_{CR}}, the 1^{st}-stage SCI format associated with the SL transmission Trᵢ^{CR} includes part or all of the information in the first coordination request (e.g., the first part of the first coordination request, or the second part of the first coordination request, or the first part of the first coordination request and the second part of the first coordination request).

Optionally, for i∈{1, . . . , N_{CR}}, the 2^{nd}-stage SCI format associated with the SL transmission Trᵢ^{CR} does not include any information in the first coordination request.

Optionally, for i∈{1, . . . , N_{CR}}, the 2^{nd}-stage SCI format associated with the SL transmission Trᵢ^{CR} includes part or all of the information in the first coordination request (e.g., the first part of the first coordination request, or the second part of the first coordination request, or the first part of the first coordination request and the second part of the first coordination request).

Optionally, for i∈{1, . . . , N_{CR}}, a source identifier indicated in the 2^{nd}-stage SCI format associated with the SL transmission Trᵢ^{CR} is a source layer-1 identifier (e.g., eight least significant bits of the first source layer-2 identifier) corresponding to the first source layer-2 identifier.

Optionally, for i∈{1, . . . , N_{CR}}, a destination identifier indicated in the 2^{nd}-stage SCI format associated with the SL transmission Trᵢ^{CR} is a destination layer-1 identifier (e.g., sixteen least significant bits of the first destination layer-2 identifier) corresponding to the first destination layer-2 identifier.

Optionally, the 2^{nd}-stage SCI formats associated with the SL transmissions T₁^{CR}, . . . , Tr_{N}_{_{CR}}^{CR} indicate the same “HARQ feedback enabled/disabled indicator” value, e.g., “enabled” or “disabled”.

Optionally, for i∈{1, . . . , N_{CR}}, j∈{1, . . . , N_{CR}}, and i≠j, the “HARQ feedback enabled/disabled indicator” values indicated in the 2^{nd}-stage SCI formats associated with the SL transmission Trᵢ^{CR} and the SL transmission Trⱼ^{CR} may be the same or different.

Optionally, for i∈{1, . . . , N_{CR}}, a transport block carried in the SL transmission Trᵢ^{CR} may include a “coordination request MAC CE”. The coordination request MAC CE includes part or all of the information in the first coordination request (e.g., the first part of the first coordination request, or the second part of the first coordination request, or the first part of the first coordination request and the second part of the first coordination request).

Optionally, a coordination request identifier (e.g., referred to as a “first coordination request identifier”) is indicated in the first coordination request. The first coordination request identifier may be an integer randomly generated by UE-B.

Optionally, for i∈{1, . . . , N_{CR}}, t₁^{CR} is indicated in the first coordination request transmitted in the slot tᵢ^{CR}. For example, t^{CR} is indicated as Δ(t^{CR},tᵢ^{CR}).

Optionally, the first coordination request corresponds to a “coordination response window” (e.g., denoted as W_{RESPONSE}^{CO}, a corresponding starting slot being tₛₜₐᵣₜ^{W}^{_{RESPONSE}}^{^{CO}}, an ending slot being t_{end}^{W}^{_{RESPONSE}}^{^{CO}}, and the size being LEN(W_{RESPONSE}^{CO})). The coordination response window may be used to indicate a time range in which a reception operation is performed with respect to a response to the first coordination request. For example, if the response is not received after the end of the slot t_{end}^{W}^{_{RESPONSE}}^{^{CO}} (or NEXT(t_{end}^{W}^{_{RESPONSE}}^{^{CO}},1), or PREV(t_{end}^{W}^{_{RESPONSE}}^{^{CO}},1)), then the response is no longer received.

Optionally, the slot tₛₜₐᵣₜ^{W}^{_{RESPONSE}}^{^{CO}} is related to one or more of t₁^{CR}, . . . , t_{N}_{_{CR}}^{CR} and N_{CR}. For example, Δ(t₁^{CR}, tₛₜₐᵣₜ^{W}^{_{RESPONSE}}^{^{CO}})=T′_{proc,1}^{CO}. As another example, Δ(t₁^{CR},tₛₜₐᵣₜ^{W}^{_{RESPONSE}}^{^{CO}})≥T′_{proc,1}^{CO}. As another example, Δ(t^{CR},tₛₜₐᵣₜ^{W}^{_{RESPONSE}}^{^{CO}})>T′_{proc,1}^{CO}. As another example, Δ(t₁^{CR},tₛₜₐᵣₜ^{W}^{_{RESPONSE}}^{^{CO}})≤T′_{proc,1}^{CO}. As another example, Δ(t₁^{CR},tₛₜₐᵣₜ^{W}^{_{RESPONSE}}^{^{CO}})<T′_{proc,1}^{CO}. As another example, Δ(t_{N}_{_{CR}}^{CR},tₛₜₐᵣₜ^{W}^{_{RESPONSE}}^{^{CO}})=T′_{proc,1}^{CO}. As another example, Δ(t_{N}_{_{CR}}^{CR},tₛₜₐᵣₜ^{W}^{_{RESPONSE}}^{^{CO}})≥T′_{proc,1}^{CO}. As another example, Δ(tₙ_{_{CR}}^{CR},tₛₜₐᵣₜ^{W}^{_{RESPONSE}}^{^{CO}})>T′_{proc,1}^{CO}. As another example, Δ(t_{N}_{_{CR}}^{CR},tₛₜₐᵣₜ^{W}^{_{RESPONSE}}^{^{CO}})≤T′_{proc,1}^{CO}. As another example, (t_{N}_{_{CR}}^{CR},tₛₜₐᵣₜ^{W}^{_{RESPONSE}}^{^{CO}})<T′_{proc,1}^{CO} may be equal to T_{proc,1}^{CO} or T_{proc,1}^{CO}+1 or T_{proc,1}^{CO}−1.

Optionally, the slot t_{end}^{W}^{_{RESPONSE}}^{^{CO}} is related to the slot t_{N}_{_{CR}}^{CR}. For example, Δ(t_{N}_{_{CR}}^{CR},t_{end}^{W}^{_{RESPONSE}}^{^{CO}})=T′_{proc,2}^{CO}. As another example, Δ(t_{N}_{_{CR}}^{CR},t_{end}^{W}^{_{RESPONSE}}^{^{CO}})≥T′_{proc,2}^{CO}. As another example, Δ(t_{N}_{_{CR}}^{CR},t_{end}^{W}^{_{RESPONSE}}^{^{CO}})>T′_{proc,2}^{CO}. As another example, Δ(t_{N}_{_{CR}}^{CR},t_{end}^{W}^{_{RESPONSE}}^{^{CO}})≤T′_{proc,2}^{CO}. As another example, Δ(t_{N}_{_{CR}}^{CR},t_{end}^{W}^{_{RESPONSE}}^{^{CO}})<T′_{proc,2}^{CO}. T′_{proc,2}^{CO} may be equal to T_{proc,2}^{CO} or T_{proc,2}^{CO}+1 or T_{proc,2}^{CO}−1.

Optionally, LEN(W_{RESPONSE}^{CO}) is related to LEN_{RESPONSE}^{CO}. For example, LEN(W_{RESPONSE}^{CO})=L_{RESPONSE}^{CO}. As another example, LEN((W_{RESPONSE}^{CO})≥L_{RESPONSE}^{CO}. As another example, LEN(W_{RESPONSE}^{CO})>L_{RESPONSE}^{CO}. As another example, LEN(W_{RESPONSE}^{CO})≤L_{RESPONSE}^{CO another example, LEN(W}_{RESPONSE}^{CO})<L_{RESPONSE}^{CO}. L_{RESPONSE}^{CO} may be a predefined or configured or pre-configured value, or may be determined by one or more predefined or configured or pre-configured parameters.

Optionally, a coordination response timer is started in the slot tₛₜₐᵣₜ^{W}^{_{RESPONSE}}^{^{CO}}. The coordination response timer may be maintained by a MAC layer entity of UE-B. The value (or referred to as “initial value”) of the coordination response timer may be equal to LEN(W_{RESPONSE}^{CO}).

Optionally, the first coordination request corresponds to a “coordination resource window” (or referred to as a “coordination resource selection window”, e.g., denoted as W_{RESOURCE}^{CO}, a corresponding starting slot being tₛₜₐᵣₜ^{W}^{_{RESOURCE}}^{^{CO}}, an ending slot being t_{end}^{W}^{_{RESOURCE}}^{^{CO}}, and the size being LEN(W_{RESOURCE}^{CO})). The coordination resource window may be used to indicate the range of slots in which coordination resources in a requested coordination resource set are located. For example, a slot in which any one of the coordination resources is located is not earlier than tₛₜₐᵣₜ^{W}^{_{RESOURCE}}^{^{CO}} (or NEXT(tₛₜₐᵣₜ^{W}^{_{RESOURCE}}^{^{CO}},1), or PREV(tₛₜₐᵣₜ^{W}^{_{RESOURCE}}^{^{CO}},1)). As another example, a slot in which any one of the coordination resources is located is not later than t_{end}^{W}^{_{RESOURCE}}^{^{CO}} (or NEXT(t_{end}^{W}^{_{RESOURCE}}^{^{CO}},1), or PREV(t_{end}^{W}^{_{RESOURCE}}^{^{CO}},1)).

Optionally, one or more parameters (e.g., t tₛₜₐᵣₜ^{W}^{_{RESOURCE}}^{^{CO}}, or t_{end}^{W}^{_{RESOURCE}}^{^{CO}}, or LEN(W_{RESOURCE}^{CO})) of the coordination resource window are indicated by the first coordination request. For example, for one or more of i∈{1, . . . , N_{CR}}, one or more of the following are indicated in the first coordination request transmitted in the slot tᵢ^{CR}:
Δ(t₁^{CR},tₛₜₐᵣₜ^{W}^{_{RESOURCE}}^{^{CO}}).
Δ(t₁^{CR},t_{end}^{W}^{_{RESOURCE}}^{^{CO}}).
Δ(tᵢ^{CR},tₛₜₐᵣₜ^{W}^{_{RESOURCE}}^{^{CO}}).
Δ(tᵢ^{CR},t_{end}^{W}^{_{RESOURCE}}^{^{CO}}).
Δ(tₛₜₐᵣₜ^{W}^{_{RESOURCE}}^{^{CO}},tₛₜₐᵣₜ^{W}^{_{RESOURCE}}^{^{CO}}).
Δ(t_{end}^{W}^{_{RESOURCE}}^{^{CO}},tₛₜₐᵣₜ^{W}^{_{RESOURCE}}^{^{CO}}).
Δ(tₛₜₐᵣₜ^{W}^{_{RESOURCE}}^{^{CO}},t_{end}^{W}^{_{RESOURCE}}^{^{CO}}).
Δ(t_{end}^{W}^{_{RESOURCE}}^{^{CO}},t_{end}^{W}^{_{RESOURCE}}^{^{CO}}).

Optionally, the slot t_{end}^{W}^{_{RESOURCE}}^{^{CO}} is related to the slot t_{end}^{W}^{_{RESOURCE}}^{^{CO}}. For example, Δ(t_{end}^{W}^{_{RESOURCE}}^{^{CO}},tₛₜₐᵣₜ^{W}^{_{RESOURCE}}^{^{CO}})=T′_{proc,3}^{CO}. As another example, Δ(t_{end}^{W}^{_{RESOURCE}}^{^{CO}},tₛₜₐᵣₜ^{W}^{_{RESOURCE}}^{^{CO}})≥T′_{proc,3}^{CO}. As another example, Δ(t_{end}^{W}^{_{RESOURCE}}^{^{CO}},tₛₜₐᵣₜ^{W}^{_{RESOURCE}}^{^{CO}})>T′_{proc,3}^{CO}. As another example, Δ(t_{end}^{W}^{_{RESOURCE}}^{^{CO}},tₛₜₐᵣₜ^{W}^{_{RESOURCE}}^{^{CO}})≤T′_{proc,3}^{CO}. As another example, Δ(t_{end}^{W}^{_{RESOURCE}}^{^{CO}},tₛₜₐᵣₜ^{W}^{_{RESOURCE}}^{^{CO}})<T′_{proc,3}^{CO}. T′_{proc,3}^{CO} may be equal to T_{proc,3}^{CO} or T_{proc,3}^{CO}+1 or T_{proc,3}^{CO}−1.

Optionally, the slot t₁^{CR} is related to the slot tₛₜₐᵣₜ^{W}^{_{RESOURCE}}^{^{CO}}. For example, Δ(t₁^{CR},tₛₜₐᵣₜ^{W}^{_{RESOURCE}}^{^{CO}})=L_{GAP0}^{CO}. As another example, Δ(t₁^{CR},tₛₜₐᵣₜ^{W}^{_{RESOURCE}}^{^{CO}})≥L_{GAP0}^{CO}. As another example Δ(t₁^{CR},tₛₜₐᵣₜ^{W}^{_{RESOURCE}}^{^{CO}})>L_{GAP0}^{CO}. As another example, Δ(t₁^{CR},tₛₜₐᵣₜ^{W}^{_{RESOURCE}}^{^{CO}})≤L_{GAP0}^{CO}. As another example Δ(t₁^{CR},tₛₜₐᵣₜ^{W}^{_{RESOURCE}}^{^{CO}})<L_{GAP0}^{CO}. L_{GAP0}^{CO} may be a predefined or configured or pre-configured value, or may be determined by one or more predefined or configured or pre-configured parameters, or may be indicated by the first coordination request.

Optionally, LEN(W_{RESOURCE}^{CO}) is related to L_{RESOURCE}^{CO}. For example, LEN(W_{RESOURCE}^{CO})=L_{RESOURCE}^{CO}. As another example, LEN(W_{RESOURCE}^{CO})≥L_{RESOURCE}^{CO}. As another example, LEN(W_{RESOURCE}^{CO})>L_{RESOURCE}^{CO}. As another example, LEN(W_{RESOURCE}^{CO})≤L_{RESOURCE}^{CO}. As another example, LEN(W_{RESOURCE}^{CO})<L_{RESOURCE}^{CO}. L_{RESOURCE}^{CO} may be a predefined or configured or pre-configured value, or may be determined by one or more predefined or configured or pre-configured parameters, or may be indicated by the first coordination request.

Optionally, a coordination resource set type (e.g., referred to as a “first coordination resource set type”) is indicated in the first coordination request. For example, the first coordination resource set type may indicate the type of a requested coordination resource set, e.g., a “set of preferred resources” or a “set of non-preferred resources”.

Optionally, the first coordination request indicates information related to data to be transmitted by UE-B (e.g., transmitted to UE-A), e.g., a transmission priority, or the number of sub-channels corresponding to each resource, or a resource reservation period.

Optionally, the first part of the first coordination request includes part or all of time-related information in the first coordination request, e.g., one or more of tₛₜₐᵣₜ^{W}^{_{RESPONSE}}^{^{CO}}, t_{end}^{W}^{_{RESPONSE}}^{^{CO}}, LEN(W_{RESPONSE}^{CO}), tₛₜₐᵣₜ^{W}^{_{RESOURCE}}^{^{CO}}, t_{end}^{W}^{_{RESOURCE}}^{^{CO}}, LEN(W_{RESOURCE}^{CO}), Δ(t₁^{CR},tᵢ^{CR}), Δ(t₁^{CR},t_{end}^{W}^{_{RESPONSE}}^{^{CO}}), Δ(t₁^{CR},tₛₜₐᵣₜ^{W}^{_{RESOURCE}}^{^{CO}}), Δ(tᵢ^{CR},t_{end}^{W}^{_{RESPONSE}}^{^{CO}}), Δ(tᵢ^{CR},tₛₜₐᵣₜ^{W}^{_{RESOURCE}}^{^{CO}}), and Δ(t_{end}^{W}^{_{RESPONSE}}^{^{CO}},tₛₜₐᵣₜ^{W}^{_{RESOURCE}}^{^{CO}}).

Further, in step S103, first coordination information is acquired. The first coordination information may be a response of UE-A to the first coordination request. For example, one or more SL transmissions are received (e.g., received in a resource pool u_{CI}), and an SL transmission used to carry the first coordination information is determined therefrom (e.g., slots in which the determined SL transmissions used to carry the first coordination information are located are respectively denoted as t₁^{CI}, . . . , t_{N}_{_{CI}}^{CI}, in chronological order, and the corresponding SL transmissions are respectively denoted as Tr₁^{CI}, . . . , Tr_{N}_{_{CI}}^{CI}, where N_{CI}>1, and in addition, N_{CI}=0 may correspond to a situation in which no SL transmission carrying the first coordination information is received). The SL transmissions Tr₁^{CI}, . . . . Tr_{N}_{_{CI}}^{CI} may be part or all of all SL transmissions that are actually transmitted by UE-A to carry the first coordination information.

Optionally, if an SL transmission satisfies a first coordination condition, the SL transmission is determined as one among Tr₁^{CI}, . . . , Tr_{N}_{_{CI}}^{CI}. The first coordination condition may include one or more of the following (in any combination of “and” or “or”):
The source identifier indicated in the 2^{nd}-stage SCI format associated with the SL transmission is equal to eight least significant bits of the first destination layer-2 identifier.
The destination identifier indicated in the 2^{nd}-stage SCI format associated with the SL transmission is equal to sixteen least significant bits of the first source layer-2 identifier.
Data of a transport block corresponding to an SL process associated with the SL transmission has been successfully decoded (e.g., successfully decoded for the first time).
The transport block corresponding to the SL process associated with the SL transmission includes a coordination information MAC CE.
A value indicated by a DST field in a MAC PDU subheader in the transport block corresponding to the SL process associated with the SL transmission is equal to eight most significant bits of the first source layer-2 identifier.
A value indicated by an SRC field in the MAC PDU subheader in the transport block corresponding to the SL process associated with the SL transmission is equal to sixteen most significant bits of the first destination layer-2 identifier.
The 1^{st}-stage SCI format associated with the SL transmission includes part or all of the first coordination information.
The 2^{nd}-stage SCI format associated with the SL transmission includes part or all of the first coordination information.
A coordination request identifier is indicated in coordination information included in the SL transmission, and the coordination request identifier is equal to the first coordination request identifier.
A coordination resource set type is indicated in coordination information included in the SL transmission, and the coordination resource set type is equal to the first coordination resource set type.

Optionally, the first coordination information is associated with the first source layer-2 identifier (or the first source layer-1 identifier) and/or the first destination layer-2 identifier (or the first destination layer-1 identifier). For example, coordination information received from a UE other than UE-A (e.g., UE-C) is not the first coordination information.

Optionally, after the first coordination information is received, the coordination response timer is stopped.

Optionally, if the coordination response timer expires, reception of the first coordination information is canceled.

Optionally, part of the first coordination information is referred to a first part of the first coordination information, and the remaining information is referred to as a second part of the first coordination information.

Optionally, the SL transmissions Tr₁^{CI}, . . . , Tr_{N}_{_{CI}}^{CI} are associated with the same 1^{st}-stage SCI format (e.g., referred to as a third SCI format).

Optionally, for i∈{1, . . . , N_{CI}}, j∈{1, . . . , N_{CI}}, and i≠j, the SL transmission Trᵢ^{CI} and the SL transmission Trⱼ^{CI} may be associated with the same 1^{st}-stage SCI format, or may be associated with different 1^{st}-stage SCI formats.

Optionally, the SL transmissions Tr₁^{CI}, . . . , Tr_{N}_{_{CI}}^{CI} are associated with the same 2^{nd}-stage SCI format (e.g., referred to as a fourth SCI format).

Optionally, for i∈{1, . . . , N_{CI}}, j∈{1, . . . , N_{CI}}, and i≠j, the SL transmission Trᵢ^{CI} and the SL transmission Trⱼ^{CI} may be associated with the same 2^{nd}-stage SCI format, or may be associated with different 2^{nd}-stage SCI formats.

Optionally, for i∈{1, . . . , N_{CI}}, the 1^{st}-stage SCI format associated with the SL transmission Trᵢ^{CI} does not include any information in the first coordination information.

Optionally, for i∈{1, . . . , N_{CI}}, the 1^{st}-stage SCI format associated with the SL transmission Trᵢ^{CI} may include part or all of the first coordination information (e.g., the first part of the first coordination information, or the second part of the first coordination information, or the first part of the first coordination information and the second part of the first coordination information).

Optionally, for i∈{1, . . . , N_{CI}}, the 2^{nd}-stage SCI format associated with the SL transmission Trᵢ^{CI} does not include any information in the first coordination information.

Optionally, for i∈{1, . . . , N_{CI}}, the 2^{nd}-stage SCI format associated with the SL transmission Trᵢ^{CI} may include part or all of the first coordination information (e.g., the first part of the first coordination information, or the second part of the first coordination information, or the first part of the first coordination information and the second part of the first coordination information).

Optionally, the 2^{nd}-stage SCI formats associated with the SL transmissions Tr₁^{CI}, . . . , Tr_{N}_{_{CI}}^{CI} indicate the same “HARQ feedback enabled/disabled indicator” value, e.g., “enabled” or “disabled”.

For i∈{1, . . . , N_{CI}}, j∈{1, . . . , N_{CI}}, and i≠j, the “HARQ feedback enabled/disabled indicator” values indicated in the 1^{st}-stage SCI formats or the 2^{nd}-stage SCI formats associated with the SL transmission Trᵢ^{CI} and the SL transmission Trⱼ^{CI} may be the same or different.

Optionally, for i∈{1, . . . , N_{CI}}, a transport block carried in the SL transmission Trᵢ^{CI} may include a “coordination information MAC CE”. The coordination information MAC CE includes part or all of the first coordination information (e.g., the first part of the first coordination information, or the second part of the first coordination information, or the first part of the first coordination information and the second part of the first coordination information).

Optionally, the first coordination information includes information of M resource indication combinations (RICs, or referred to as resource combinations), wherein the value range of M may be determined by one or more predefined or configured or pre-configured parameters, for example, M≥Mₘᵢₙ, and as another example, M≤Mₘₐₓ. Optionally, Mₘᵢₙ (or Mₘᵢₙ+1, or Mₘᵢₙ−1) may be a predefined or configured or pre-configured value, or may be determined by one or more predefined or configured or pre-configured parameters, or may be autonomously determined by UE-B, or may be determined in another manner. For example, Mₘᵢₙ=1. As another example, Mₘᵢₙ=0. Optionally, Mₘₐₓ (or Mₘₐₓ+1, or Mₘₐₓ−1) may be a predefined or configured or pre-configured value, or may be determined by one or more predefined or configured or pre-configured parameters, or may be autonomously determined by UE-B, or may be determined in another manner. Optionally, when M≥1, the M RICs may be respectively denoted as RIC₁, . . . , RIC_{M}.

Optionally, the M RICs are used to indicate a coordination resource set (e.g., denoted as S_{RES}^{CO}, wherein a resource pool in which a resource in the coordination resource set S_{RES}^{CO} is located is denoted as u_{RES}^{CO}).

Optionally, for m∈{1, . . . , M}, RICₘ may include one or more of TRIVₘ, FRIVₘ, or P_{rsvp,m}, wherein TRIVₘ is a time resource indicator value (TRIV), FRIVₘ is a frequency resource indicator value (FRIV), and P_{rsvp,m} is a resource reservation period (RRP), wherein P_{rsvp,m} may represent the number of milliseconds, or the number of physical slots, or the number of SL slots, or the number of logical slots in the resource reservation period. For example, RICₘ may be defined as one of the following:
(TRIVₘ, FRIVₘ).
(TRIVₘ, FRIVₘ, P_{rsvp,m}).

Optionally, the definition and/or determination method of RICₘ may be related to the type of the coordination resource set S_{RES}^{CO}. For example, if the coordination resource set s_{RES}^{CO} is a set of preferred resources, then RIC=(TRIVₘ, FRIVₘ). As another example, if the coordination resource set S_{RES}^{CO} is a set of preferred resources, then P_{rsvp,m} is skipped (for example, when RICₘ is transmitted, P_{rsvp,m} is skipped, i.e., RIC=(TRIVₘ, FRIVₘ), and as another example, when RICₘ=(TRIVₘ, FRIVₘ, P_{rsvp,m}) is received, P_{rsvp,m} in received RICₘ is skipped). As another example, if the coordination resource set s_{RES}^{CO} is a set of non-preferred resources, then RICₘ=(TRIVₘ, FRIVₘ, P_{rsvp,m}).

Optionally, for m∈{1, . . . , M}, TRIVₘ and FRIVₘ indicate N_{RES}^{RIV,m} resources in the coordination resource set S_{RES}^{CO}. The value range of N_{RES}^{RIV,m} may be determined by one or more predefined or configured or pre-configured parameters. For example, N_{RES}^{RIV,m}≥N_{RES,min}^{RIV}. As another example, N_{RES}^{RIV,m}≤N_{RES,max}^{RIV}. Optionally, N_{RES,min}^{RIV} (or N_{RES,min}^{RIV}+1, or N_{RES,min}^{RIV}−1) may be a predefined or configured or pre-configured value, or may be determined by one or more predefined or configured or pre-configured parameters, or may be autonomously determined by UE-B, or may be determined in another manner. For example, N_{RES,min}^{RIV}=1. As another example, N_{RES,min}^{RIV}=0. Optionally, N_{RES,max}^{RIV} (or N_{RES,max}^{RIV}+1, or N_{RES,max}^{RIV}−1) may be a predefined or configured or pre-configured value (e.g., the value of a higher-layer parameter sl-MaxNumPerReserve), or may be determined by one or more predefined or configured or pre-configured parameters (e.g., determined by the higher-layer parameter sl-MaxNumPerReserve), or may be autonomously determined by UE-B, or may be determined in another manner. For example, N_{RES,max}^{RIV}=1. As another example, N_{RES,max}^{RIV}=2. As another example, N_{RES,max}^{RIV}=3. As another example, N_{RES,max}^{RIV}=4.

Optionally, when N_{RES}^{RIV,m}≥1, slots in which the N_{RES}^{RIV,m} resources are located may be respectively denoted as t₁^{RIV,m}, . . . , t_{N}_{_{RES}}_{^{RIV,m}}^{RIV,m} in chronological order, and the corresponding N_{RES}^{RIV,m} resources may be respectively denoted as t₁^{RIV,m}, . . . , t_{N}_{_{RES}}_{^{RIV,m}}^{RIV,m}. Optionally, slots t₁^{RIV,m}, . . . , t_{N}_{_{RES}}_{^{RIV,m}}^{RIV,m} are different from each other. Optionally, resources t₁^{RIV,m}, . . . , t_{N}_{_{RES}}_{^{RIV,m}}^{RIV,m} correspond to the same number of sub-channels, e.g., denoted as L_{subCH}^{RIV,m} (e.g., representing L_{subCH}^{RIV,m} consecutive sub-channels). Optionally, resources r₁^{RIV,m}, . . . , r_{N}_{_{RES}}_{^{RIV,m}}^{RIV,m} may be respectively referred to as a “second RIC resource”, . . . , a “(N_{RES}^{RIV,m}+1)-th RIC resource” corresponding to RICₘ. For example, if N_{RES}^{RIV,m}=2, then resources r₁^{RIV,m} and r₂^{RIV,m} may be respectively referred to as a second RIC resource and a third RIC resource corresponding to RICₘ (or TRIVₘ).

Optionally, N_{RES}^{RIV,1}= . . . =N_{RES}^{RIV,M}=N_{RES}^{RIV}. Optionally, N_{RES}^{RIV} is a predefined or configured or pre-configured value, or is determined by one or more predefined or configured or pre-configured parameters, or is indicated by the first coordination request, or is indicated by the first coordination information, or is determined in another manner. For example, N_{RES}^{RIV}=1. As another example, N_{RES}^{RIV}=2. As another example, N_{RES}^{RIV}=3. As another example, N_{RES}^{RIV}=4. As another example, N_{RES}^{RIV}=0.

Optionally, for m₁∈{1, . . . , M}, m₂∈{1, . . . , M}, and m₁≠m₂, N_{RES}^{RIV,m}^{₁} and N_{RES}^{RIV,m}^{₂} may be equal or unequal.

Optionally, the first coordination information indicates M “first RIC resource locations”, and each “first RIC resource location” may correspond to one “first RIC resource” (e.g., the M “first RIC resources” are sequentially denoted as r₀^{RIV,m}, . . . , r_{N}_{_{RES}}_{^{RIV,m}}^{RIV,m}, and slots in which the resources r₀^{RIV,1}, . . . , r₀^{RIV,M} are located are respectively denoted as t₁^{RIV,ref}, . . . , t_{M}^{RIV,ref}, and starting sub-channels being respectively denoted as n_{subCH,0}^{RIV,1,start}, . . . , n_{subCH,0}^{RIV,M,start}). For m∈{1, . . . , M}, the number of sub-channels corresponding to the resource r₀^{RIV,m} may be equal to L_{subCH}^{RIV,m}.

Optionally, for m∈{1, . . . , M}, the resource r₀^{RIV,m} may be associated with RICₘ. For example, for RICₘ, the resource r₀^{RIV,m} may correspond to the “first resource” in the SL resource reservation procedure, and the resources r₁^{RIV,m}, . . . , r_{N}_{_{RES}}_{^{RIV,m}}^{RIV,m} may respectively correspond to the “second resource”, . . . , the “(N_{RES}^{RIV,m}+1)-th resource” in the SL resource reservation procedure.

Optionally, the “first RIC resource location” may refer to a time domain location, a frequency domain location, or both time domain and frequency domain locations of the corresponding “first RIC resource”.

Optionally, the resources r₀^{RIV,1}, . . . , r₀^{RIV,M} belong to the coordination resource set Optionally, the resources r₀^{RIV,1}, . . . , r₀^{RIV,M} do not belong to the coordination resource set S_{RES}^{CO} (e.g., the resources r₀^{RIV,1}, . . . , r₀^{RIV,M} may be considered as “virtual resources” used to provide reference locations for other resources).

Optionally, the slots t₁^{RIV,ref}, . . . t_{M}^{RIV,ref} may be indicated in one or more of the following manners:
For m∈{1, . . . , M}, the slot tₘ^{RIV,ref} is indicated as Δ(t_{0,0}^{RIV,ref},tₘ^{RIV,ref}) Δ(tₘ^{RIV,ref},t_{0,0}^{RIV,ref}).
For m∈{1, . . . , M}, the slot tₘ^{RIV,ref} is indicated as Δ(t_{0,m}^{RIV,ref},tₘ^{RIV,ref}) or Δ(t_{0,0}^{RIV,ref},t_{0,m}^{RIV,ref})
The slot t₁^{RIV,ref} is indicated as Δ(t₀^{RIV,ref},t₁^{RIV,ref}) or Δ(t₁^{RIV,ref},t₀^{RIV,ref}).
For m∈{2, . . . , M}, the slot tₘ^{RIV,ref} is indicated as Δ(tₘ₋₁^{RIV,ref},tₘ^{RIV,ref}) or Δ(tₘ^{RIV,ref},tₘ₋₁^{RIV,ref}).

### Wherein,

Optionally, t_{0,0}^{RIV,ref}=t_{0,0}^{RIV}, or t_{0,0}^{RIV,ref}=NEXT(t_{0,0}^{RIV},D_{0,0}^{RIV}), or t_{0,0}^{RIV,ref}=PREV(t_{0,0}^{RIV},D_{0,0}^{RIV}), where D_{0,0}^{RIV} may be a predefined or configured or pre-configured value (e.g., D_{0,0}^{RIV}=−1, or D_{0,0}^{RIV}=0, or D_{0,0}^{RIV}=1), or may be determined by one or more predefined or configured or pre-configured parameters, or may be indicated by the first coordination request, or may be indicated by the first coordination information, or may be related to LEN(W_{RESOURCE}^{CO}).
Optionally, for m∈{1, . . . , M}, t_{0,m}^{RIV,ref}=t_{0,0}^{RIV}, or t_{0,m}^{RIV,ref}=NEXT(t_{0,0}^{RIV},D_{0,m}^{RIV}), or t_{0,m}^{RIF,ref}=PREV(t_{0,0}^{RIV}D_{0,m}^{RIV}), where D_{0,m}^{RIV} may be equal to (m+F_{0,0}^{RIV})·G_{0,0}^{RIV}+E_{0,0}^{RIV}, and any one among F_{0,0}^{RIV}, G_{0,0}^{RIV} and E_{0,0}^{RIV} may be a predefined or configured or pre-configured value (e.g., F_{0,0}^{RIV}=−1 or F_{0,0}^{RIV}=0 or F_{0,0}^{RIV}=1, and G_{0,0}^{RIV}=−1 or G_{0,0}^{RIV}=0 or G_{0,0}^{RIV}=1 or G_{0,0}^{RIV}=29 or G_{0,0}^{RIV}=30 or G_{0,0}^{RIV}=31 or G_{0,0}^{RIV}=32 or G_{0,0}^{RIV}=33, and E_{0,0}^{RIV}=−1 or E_{0,0}^{RIV}=0 or E_{0,0}^{RIV}=1), or may be determined by one or more predefined or configured or pre-configured parameters, or may be indicated by the first coordination request, or may be indicated by the first coordination information, or may be related to LEN(W_{RESOURCE}^{CO}).

Optionally, for m∈{1, . . . , M}, tₘ^{RIV,ref} and/or n_{subCH,0}^{RIV,m,start} may be considered as part of RICₘ, and correspondingly, indications for tₘ^{RIV,ref} and/or n_{subCH,0}^{RIV,m,start} may be included in an indication for RICₘ (i.e., the M “first RIC resource locations” are not separately indicated). For example, RICₘ may be defined as one of the following:
(TRIVₘ,FRIVₘ,tₘ^{RIV,ref}).
(TRIVₘ,FRIVₘ,P_{rsvp,m},tₘ^{RIV,ref}).
(TRIVₘ,FRIVₘ,n_{subCH,0}^{RIV,m,start}).
(TRIVₘ,FRIVₘ,P_{rsvp,m},n_{subCH,0}^{RIV,m,start}).
(TRIVₘ,FRIVₘ,tₘ^{RIV,ref},n_{subCH,0}^{RIV,m,start}).
(TRIVₘ,FRIVₘ,P_{rsvp,m},tₘ^{RIV,ref},n_{subCH,0}^{RIV,m,start}).

Optionally, for m∈{1, . . . , M}, TRIVₘ may indicate N_{RES}^{RIV,m} and slot offsets Δ(tₘ^{RIV,ref},t₁^{RIV,m}), . . . , Δ(tₘ^{RIV,ref},t_{N}_{_{RES}}_{^{RIV,m}}^{RIV,m}) and FRIVₘ, may indicate starting sub-channels (e.g., respectively denoted as n_{subCH,1}^{RIV,m,start}, . . . , n_{subCH,N}_{_{RES}}_{^{RIV,m}}^{RIV,m,start}) respectively corresponding to resources r₁^{RIV,m}, . . . , t_{N}_{_{RES}}_{^{RIV,m}}^{RIV,m} and the number L_{subCH}^{RIV,m} of sub-channels corresponding to each resource among resources r₁^{RIV,m}, . . . , t_{N}_{_{RES}}_{^{RIV,m}}^{RIV,m}. Specifically, for example, the definitions of the TRIV and the FRIV in the SL resource reservation procedure may be appropriately modified to be used to respectively explain TRIVₘ and FRIVₘ, wherein the modification may include one or more of the following:
Replacing the TRIV with TRIVₘ.
Replacing the FRIV with FRIVₘ.
Replacing the first resource with the first RIC resource.
Replacing the second resource with the second RIC resource.
Replacing the third resource with the third RIC resource.
Not using (or skipping, or discarding) the “first resource”.
Not using (or skipping, or discarding) the “first RIC resource”.
Replacing the slot t₀^{SL,RES} (or “the slot in which the SCI is received”) with the slot tₘ^{RIV,ref} (i.e., “the first RIC resource location” corresponding to TRIVₘ).
A slot offset of the second resource is t₁−T₁^{SL,RES}. T₁^{SL,RES} may be a predefined or configured or pre-configured value (e.g., T₁^{SL,RES}=−1 or T₁^{SL,RES}=0 or T₁^{SL,RES}=1), or may be determined by one or more predefined or configured or pre-configured parameters, or may be indicated by the first coordination request, or may be indicated by the first coordination information, or may be related to LEN(W_{RESOURCE}^{CO}).
A slot offset of the third resource is t₂−T₂^{SL,RES}. T₂^{SL,RES} may be a predefined or configured or pre-configured value (e.g., T₂^{SL,RES}=1, or T₂^{SL,RES}=0, or T₂^{SL,RES}=1), or may be determined by one or more predefined or configured or pre-configured parameters, or may be indicated by the first coordination request, or may be indicated by the first coordination information, or may be related to LEN(W_{RESOURCE}^{CO}).
Replacing the slot offset t₁ with the slot offset Δ(tₘ^{RIV,ref},t₁^{RIV,m}).
Replacing the slot offset t₂ with the slot offset Δ(tₘ^{RIV,ref},t₂^{RIV,m}).
Replacing the starting sub-channel n_{subCH,1}^{start} with the starting sub-channel n_{subCH,1}^{RIV,m,start}.
Replacing the starting sub-channel n_{subCH,2}^{start} with the starting sub-channel n_{subCH,2}^{RIV,m,start}.
Replacing the SCI (or “the received SC”) with (TRIVₘ, FRIVₘ).
Replacing N with N_{RES}^{RIV,m}+1 (e.g., N may represent the resource r₀^{RIV,m} and the total number of resources corresponding to r₁^{RIV,m}, . . . ,r_{N}_{_{RES}}_{^{RIV,m}}^{RIV,m}).
Replacing N_{subchannel}^{SL} with the number N_{subchannel}^{SL,u}^{_{RES}}^{^{CO}} se of sub-channels of the resource pool u_{RES}^{CO}.
Configuring the value of sl-MaxNumPerReserve as a fixed value (e.g., 2 or 3).
Replacing sl-MaxNumPerReserve with another parameter (e.g., denoted as sl-MaxNumPerReserveRlC), wherein the value of sl-MaxNumPerReserveRIC may be a predefined or configured or pre-configured value, or may be determined by one or more predefined or configured or pre-configured parameters, or may be indicated by the first coordination request, or may be indicated by the first coordination information.

Optionally, for m∈{1, . . . , M} and i∈{1, . . . , N_{RES}^{IRV,m}}, P_{rsvp,m} (or RICₘ) may indicate C_{RESEL,0}^{RRI,m,i} resources in the coordination resource set S_{RES}^{CO}, where C_{RESEL,0}^{RRI,m,i} may be an integer greater than or equal to 0, or an integer greater than or equal to 1. When C_{RESEL,0}^{RRI,m,i}≥1, the slots in which the C_{RESEL,0}^{RRI,m,i} resources are located may be respectively denoted as t_{i,1}^{RRI,m}, . . . , t_{i,C}_{_{RESEL,0}}_{^{RRI,m,i}}^{RRI,m} in chronological order, and the corresponding resources may be respectively denoted as r_{i,1}^{RRI,m}, . . . , r_{i,C}_{_{RESEL,0}}_{^{RRI,m,i}}^{RRI,m}. Optionally, in the frequency domain, each of the resources r_{i,1}^{RRI,m}, . . . , r_{i,C}_{_{RESEL,0}}_{^{RRI,m,i}}^{RRI,m} corresponds to the same sub-channel set (i.e., L_{subCH}^{RIV,m} consecutive sub-channels with n_{subCH,i}^{RIV,m,start} being the starting sub-channel) as the resource rᵢ^{RIV,m}. Optionally, in the time domain, for j∈{1, . . . , C_{RESEL,0}^{RRI,m,i}}, t_{i,j}^{RRI,m}=NEXT(tᵢ^{RIV,m},j×P_{RSVP}^{RRI,m}), where P_{RSVP}^{RRI,m} may be the number of logical slots corresponding to P_{rsvp,m} (e.g., P_{rsvp,m} represents the number of milliseconds in a corresponding resource reservation period, and

$${P}_{RSVP}^{RRI , m} = ⌈ \frac{{T}_{max}^{′ {u}_{RES}^{CO}}}{1 \; 0240 ms} \times {P}_{rsvp , m} ⌉ ;$$

or P_{rsvp,m} represents the number of logical slots in a corresponding resource reservation period, and P′_{rsvp,m}=P_{rsvp,m}), or may be equal to P_{rsvp,m}. The C_{RESEL,0}^{RRI,m,i} resources may be referred to as periodically reserved resources corresponding to the resource rᵢ^{RIV,m}.

Optionally, if RICₘ does not include P_{rsvp,m} (or P_{rsvp,m} is skipped, or P_{rsvp,m}=P_{rsvp,0}, wherein P_{rsvp,0} is a predefined or configured or pre-configured value, or is determined by one or more predefined or configured or pre-configured parameters, or is indicated by the first coordination request, or is indicated by the first coordination information, e.g., P_{rsvp,0}=0), then C_{RESEL,0}^{RRI,m,i}=0.

Optionally, for m∈{1, . . . , M} and i∈{1, . . . , N_{RES}^{RIV,m}}, C_{RESEL,0}^{RRI,m,i} is equal to one among C_{RESEL}^{RRI,m,i}, C_{RESEL}^{RRI,m,i}+1, and C_{RESEL}^{RRI,m,i}−1. Optionally C_{RESEL}^{RRI,m,i} is a predefined or configured or pre-configured value, or is determined by one or more predefined or configured or pre-configured parameters, or is indicated by the first coordination request, or is indicated by the first coordination information.

Optionally, for m∈{1, . . . , M}, C_{RESEL}^{RRI,m,1}= . . . =C_{RESEL,0}^{RRI,m,N}^{_{RES}}^{^{RIV,m}}=C_{RESEL}^{RRI,m}, where C_{RESEL}^{RRI,m} is a predefined or configured or pre-configured value, or is determined by one or more predefined or configured or pre-configured parameters, or is indicated by the first coordination request, or is indicated by the first coordination information.

Optionally, C_{RESEL}^{RRI,1}= . . . =C_{RESEL}^{RRI,N}^{_{RES}}^{^{RIV,m}}=C_{RESEL}^{RRI}, where C_{RESEL}^{RRI} is a predefined or configured or pre-configured value, or is determined by one or more predefined or configured or pre-configured parameters, or is indicated by the first coordination request, or is indicated by the first coordination information.

Optionally, for m∈{1, . . . , M} and i∈{1, . . . , N_{RES}^{RIV,m}}, C_{RESEL}^{RRI,m,i} is related to one or more parameters (e.g., L_{WND}^{CO,RESOURCE}, t_{WND,start}^{CO,RESOURCE}, or t_{WND,end}^{CO,RESOURCE}) of the coordination resource window and/or P_{rsvp,m} and/or P_{RSVP}^{RRI,m}. For example, C_{RESEL}^{RRI,m,i} is the maximum value of j that causes the slot t_{i,j}^{RRI,m}=NEXT(tᵢ^{RIV,m},j×P_{RSVP}^{RRI,m}) to fall within the coordination resource window. As another example, if a first resource reservation period condition is satisfied, then

$${C}_{RESEL}^{RRI , m , i} = ⌈ \frac{{T}_{SCAL}^{RRI}}{{P}_{RSVP}^{RRI , m}} ⌉ .$$

As another example, if the first resource reservation period condition is not satisfied, then C_{RESEL}^{RRI,m,i}=1 (or C_{RESEL}^{RRI,m,i}=0, or C_{RESEL}^{RRI,m,i}=2). As another example, if a second resource reservation period condition is satisfied, then C_{RESEL}^{RRI,m,i}=1 (or C_{RESEL}^{RRI,m,i}=0, or C_{RESEL}^{RRI,m,i}=2). As another example, if the second resource reservation period condition is not satisfied, then

$${C}_{RESEL}^{RRI , m , i} = ⌈ \frac{{T}_{SCAL}^{RRI}}{{P}_{RSVP}^{RRI , m}} ⌉ .$$

Optionally, T_{SCAL}^{RRI} may be related to one or more among LEN(W_{RESOURCE}^{CO}), tᵢ^{RIV,m}, tₛₜₐᵣₜ^{W}^{_{RESOURCE}}^{^{CO}} or t_{end}^{W}^{_{RESOURCE}}^{^{CO}}. For example, T_{SCAL}^{RRI}=LEN(W_{RESOURCE}^{CO}). As another example, T_{SCAL}^{RRI}=LEN(W_{RESOURCE}^{CO})+1. As another example, T_{SCAL}^{RRI}=LEN(W_{RESOURCE}^{CO})−1. As another example, T_{SCAL}^{RRI}=Δ(tᵢ^{RIV,m},t_{end}^{W}^{_{RESOURCE}}^{^{CO}}). As another example, T_{SCAL}^{RRI}=Δ(tᵢ^{RIV,m},t_{end}^{W}^{_{RESOURCE}}^{^{CO}})+1. As another example, T_{SCAL}^{RRI}=Δ(tᵢ^{RIV,m},t_{end}^{W}^{_{RESOURCE}}^{^{CO}})−1. As another example, T_{SCAL}^{RRI}=LEN(W_{RESOURCE}^{CO})−Δ(tₛₜₐᵣₜ^{W}^{_{RESOURCE}}^{^{CO}},tᵢ^{RIV,m}) As another example, T_{SCAL}^{RRI}=LEN(W_{RESOURCE}^{CO})−Δ(tₛₜₐᵣₜ^{W}^{_{RESOURCE}}^{^{CO}},tᵢ^{RIV,m})+1. As another example, T_{SCAL}^{RRI}=LEN(W_{RESOURCE}^{CO})−Δ(tₛₜₐᵣₜ^{W}^{_{RESOURCE}}^{^{CO}},tᵢ^{RIV,m})−1.

Optionally, the first resource reservation period condition may include one or more of the following (in any combination of “and” or “or”):
P_{RSVP}^{RRI,m}<T_{SCAL}^{RRI}.
P_{RSVP}^{RRI,m}≤T_{SCAL}^{RRI}.

Optionally, the second resource reservation period condition may include one or more of the following (in any combination of “and” or “or”):
P_{RSVP}^{RRI,m}>T_{SCAL}^{RRI}.
P_{RSVP}^{RRI,m}≥T_{SCAL}^{RRI}.

Optionally, the first part of the first coordination information includes one or more of the following:
M.
The M RICs (e.g., RIC₁, . . . , RIC_{M} in order).
The M “first RIC resources locations” (e.g., t₁^{RIV,ref}, . . . , t_{M}^{RIV,ref} in order).
The second coordination resource set type.
The second coordination request identifier.

Optionally, the second part of the first coordination information includes one or more of the following:
M.
The M RICs (e.g., RIC₁, . . . , RIC_{M} in order).
The M “first RIC resources locations” (e.g., t₁^{RIV,ref}, . . . , t_{M}^{RIV,ref} in order).
The second coordination resource set type.
The second coordination request identifier.

Optionally, the coordination information MAC CE includes a “coordination information control element” field. Optionally, the content of the coordination information control element field includes one or more of the following parameters (e.g., arranged in the following order, or arranged in any other order, such as starting from the most significant bit, or starting from the least significant bit):
M.
The M RICs (e.g., RIC₁, . . . , RIC_{M} in order).
The M first RIC resources locations (e.g., t₁^{RIV,ref}, . . . , t_{M}^{RIV,ref} in order).
The second coordination resource set type.
The second coordination request identifier.

Optionally, the length and/or type of the coordination information control element field may be related to one or more of the following:
The number N_{subchannel}^{SL,u}^{_{RES}}^{^{CO}} of sub-channels of the resource pool u_{RES}^{CO}.
The number N_{rsv_period}^{SL,u}^{_{RES}}^{^{CO}} of resource reservation periods of the resource pool u_{RES}^{CO}.

Optionally, if the sum (e.g., denoted as L_{RAW}^{CO,CI}, and e.g., representing L_{RAW}^{CO,CI} bits) of the lengths of all parameters corresponding to the coordination information control element field is not a multiple (e.g., an integer multiple) of 8, then a bit ‘0’ is added at the end of the content of the coordination information control element field, so that the length (e.g., denoted as L_{MACCE}^{CO,RESSET}, and e.g., representing L_{MACCE}^{CO,RESSET}, bits) of the coordination information control element field is a multiple (e.g., an integer multiple) of 8. Specifically, for example, if the parameters corresponding to the coordination information control element field are sequentially {RIC₁, . . . , RIC_{M}, r₁^{RIV,ref}, . . . , r_{M}^{RIV,ref}}, and for m∈{1, . . . , M}, the lengths of RICₘ and tₘ^{RIV,ref} are respectively L_{ONE}^{CO,RIC} and L_{ONE}^{CO,RIV,REF}, then L_{RAW}^{CO,RESET}=M·(L_{ONE}^{CO,RIC}+L_{ONE}^{CO,RIV,REF}), and correspondingly, (8−(L_{RAW}^{CO,RESSET} mod 8)) bits ‘0’ are added at the end of the content of the coordination information control element field.

Optionally, for m∈{1, . . . , M}, RICₘ corresponds to a “RICₘ control element” field in the coordination information MAC CE. The type of the “RICₘ control element” field may be one among a plurality of predefined types.

Optionally, the type of the “RICₘ control element” field may be related to one or more of the following:
The number N_{subchannel}^{SL,u}^{_{RES}}^{^{CO}} of sub-channels of the resource pool u_{RES}^{CO}.
The number N_{rsv_period}^{SL,u}^{_{RES}}^{^{CO}} of resource reservation periods of the resource pool u_{RES}^{CO}.

For example, for RIC=(TRIVₘ, FRIVₘ), the type of the “RICₘ control element” field is determined in one or more of the following manners:
If N₁^{SC,RIC1}≤N_{subchannel}^{SL,u}^{_{RES}}^{^{CO}}≤N₂^{SC,RIC1} then the type of the “RICₘ control element” field is a “first RIC control element type”. Specifically, for example, N₁^{SC,RIC1}=1, and N₂^{SC,RIC1}=6. FIG. 4 shows an example of the first RIC control element type.
If N₃^{SC,RIC1}≤N_{subchannel}^{SL,u}^{_{RES}}^{^{CO}}≤N₄^{SC,RIC1}, then the type of the “RICₘ control element” field is a “second RIC control element type”. Specifically, for example, N₃^{SC,RIC1}=7, and N₄^{SC,RIC1}=27. FIG. 5 shows an example of the second RIC control element type.

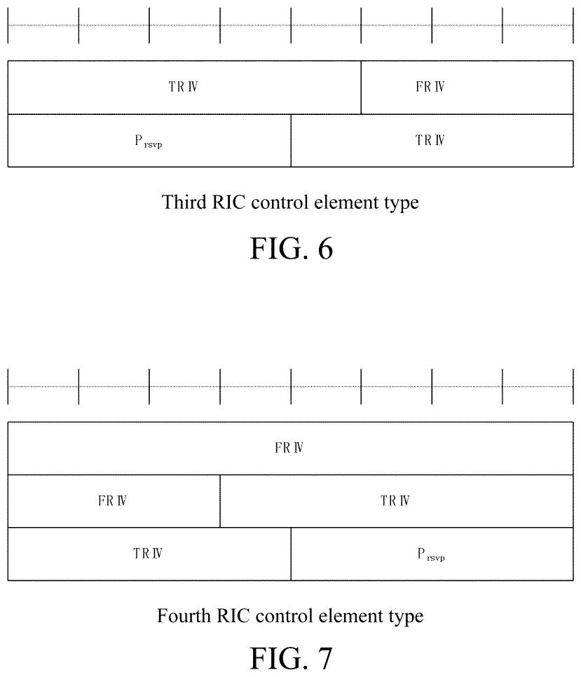

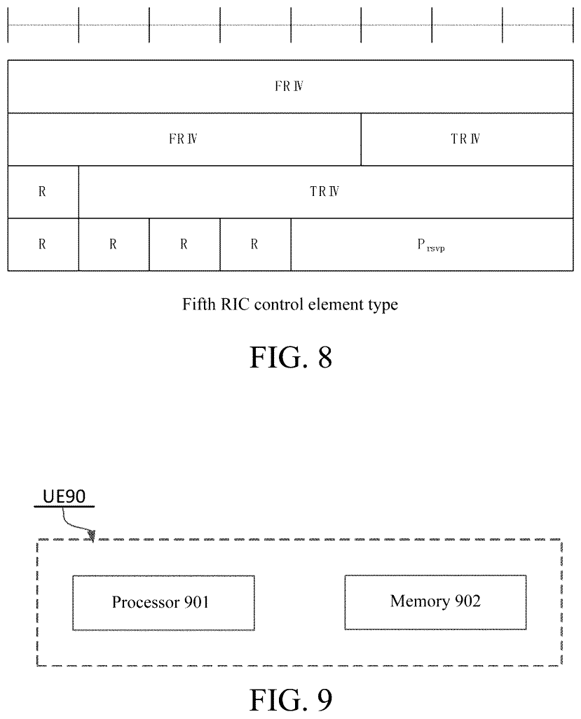

As another example, for RICₘ=(TRIVₘ, FRIVₘ, P_{rsvp,m}), the type of the “RICₘ control element” field is determined in one or more of the following manners:
If N₁^{SC,RIC2}≤N_{subchannel}^{SL,u}^{_{RES}}^{^{CO}}≤N₂^{SC,RIC2}, then the type of the “RICₘ control element” field is a “third RIC control element type”. Specifically, for example, N₁^{SC,RIC2}=1, and N₂^{SC,RIC2}=2. FIG. 6 shows an example of the third RIC control element type.
If N₃^{SC,RIC2}≤N_{subchannel}^{SL,u}^{_{RES}}^{^{CO}}≤N₄^{SC,RIC2}, then the type of the “RICₘ control element” field is a “fourth RIC control element type”. Specifically, for example, N₃^{SC,RIC2}=3, and N₄^{SC,RIC2}=17. FIG. 7 shows an example of the fourth RIC control element type.
If N₅^{SC,RIC2}≤N_{subchannel}^{SL,u}^{_{RES}}^{^{CO}}≤N₆^{SC,RIC2}, then the type of the “RICₘ control element” field is a “fifth RIC control element type”. Specifically, for example, N₅^{SC,RIC2}=18, N₆^{SC,RIC2}=27. FIG. 8 shows an example of the fifth RIC control element type.

Optionally, if an SL transmission satisfies a second coordination condition, a second coordination operation is performed on the SL transmission.

Optionally, the second coordination condition may include one or more of the following (in any combination of “and” or “or”):
The inter-UE coordination function is not enabled.
The first coordination scheme is not enabled.
The inter-UE coordination function is enabled.
The first coordination scheme is enabled.
The 1^{st}-stage SCI format associated with the SL transmission includes part or all of the coordination information.
The 2^{nd}-stage SCI format associated with the SL transmission includes part or all of the coordination information (e.g., the 2^{nd}-stage SCI format is SCI format 2-C, or the 2^{nd}-stage SCI format is SCI format 2-D).
UE-B is incapable of receiving and/or processing the 1^{st}-stage SCI format including the coordination information.
UE-B is incapable of receiving and/or processing the 2^{nd}-stage SCI format (e.g., SCI format 2-C, or SCI format 2-D) including the coordination information.
UE-B is incapable of receiving and/or processing the coordination information included in the 1^{st}-stage SCI format associated with the SL transmission.
UE-B is incapable of receiving and/or processing the coordination information included in the 2^{nd}-stage SCI format associated with the SL transmission.
The source identifier indicated in the 2^{nd}-stage SCI format associated with the SL transmission is not equal to the first destination layer-1 identifier.
The destination identifier indicated in the 2^{nd}-stage SCI format associated with the SL transmission is not equal to the first source layer-1 identifier.
The coordination request identifier indicated in the 1^{st}-stage SCI format associated with the SL transmission is not equal to the first coordination request identifier.
The coordination request identifier indicated in the 2^{nd}-stage SCI format associated with the SL transmission is not equal to the first coordination request identifier.
The coordination resource set type indicated in the 1^{st}-stage SCI format associated with the SL transmission is not equal to the first coordination resource set type.
The coordination resource set type indicated in the 2^{nd}-stage SCI format associated with the SL transmission is not equal to the first coordination resource set type.
The “HARQ feedback enabled/disabled indicator” value indicated in the 2^{nd}-stage SCI format associated with the SL transmission is “enabled”.
The “HARQ feedback enabled/disabled indicator” value indicated in the 2^{nd}-stage SCI format associated with the SL transmission is “disabled”.

Optionally, the second coordination operation may include one or more of the following:
Discarding (or skipping) the 1^{st}-stage SCI format associated with the SL transmission.
Discarding (or skipping) the 2^{nd}-stage SCI format associated with the SL transmission.
Discarding (or skipping) the coordination information indicated in the 1^{st}-stage SCI format associated with the SL transmission.
Discarding (or skipping) the coordination information indicated in the 2^{nd}-stage SCI format associated with the SL transmission.
Discarding (or skipping) the coordination resource set indicated in the 1^{st}-stage SCI format associated with the SL transmission.
Discarding (or skipping) the coordination resource set indicated in the 2^{nd}-stage SCI format associated with the SL transmission.
Discarding (or skipping) the transport block carried in the SL transmission.
Generating a negative acknowledgment for the transport block (or data in the transport block) carried in the SL transmission. For example, a MAC layer entity of UE-B instructs a physical layer entity of UE-B to generate the negative acknowledgment.

Optionally, if a transport block satisfies a third coordination condition, a third coordination operation is performed on the transport block.

Optionally, the third coordination information processing condition may include one or more of the following (in any combination of “and” or “or”):
The inter-UE coordination function is not enabled.
The first coordination scheme is not enabled.
The inter-UE coordination function is enabled.
The first coordination scheme is enabled.
Data of the transport block has been successfully decoded (e.g., successfully decoded for the first time).
The transport block includes a coordination information MAC CE.
The 1^{st}-stage SCI format associated with one or more SL transmissions carrying the transport block includes part or all of the coordination information.
The 2^{nd}-stage SCI format associated with one or more SL transmissions carrying the transport block includes part or all of the coordination information (e.g., the 2^{nd}-stage SCI format is SCI format 2-C, or the 2^{nd}-stage SCI format is SCI format 2-D).
UE-B is capable of receiving and/or processing the 1^{st}-stage SCI format including the coordination information.
UE-B is capable of receiving and/or processing the 2^{nd}-stage SCI format (e.g., SCI format 2-C, or SCI format 2-D) including the coordination information.
UE-B has processed the coordination information included in the 1^{st}-stage SCI format associated with one or more SL transmissions carrying the transport block.
UE-B has processed the coordination information included in the 2^{nd}-stage SCI format associated with one or more SL transmissions carrying the transport block.

Optionally, the third coordination operation may include: discarding (or skipping) the coordination information MAC CE in the transport block.

Optionally, if a transport block satisfies a fourth coordination condition, then a fourth coordination operation is performed on the transport block.

Optionally, the fourth coordination condition may include one or more of the following (in any combination of “and” or “or”):
The inter-UE coordination function is not enabled.
The first coordination scheme is not enabled.
The inter-UE coordination function is enabled.
The first coordination scheme is enabled.
Data of the transport block has been successfully decoded (e.g., successfully decoded for the first time).
The transport block includes a coordination information MAC CE.
UE-B has not processed the 1^{st}-stage SCI format that corresponds to any SL transmission carrying the transport block and that includes the coordination information.
UE-B has not processed the 2^{nd}-stage SCI format (e.g., SCI format 2-C, or SCI format 2-D) that corresponds to any SL transmission carrying the transport block and that includes the coordination information.
UE-B has not processed the coordination information in the 1^{st}-stage SCI format corresponding to any SL transmission carrying the transport block.
UE-B has not processed the coordination information in the 2^{nd}-stage SCI format corresponding to any SL transmission carrying the transport block.

Optionally, the fourth coordination operation may include: processing the coordination information MAC CE (e.g., determining time domain and frequency domain locations of each resource in a corresponding coordination resource set s_{RES}^{CO}, performing resource selection/reselection, and so on).

Optionally, in Embodiment 1 of the present invention, t_{0,0}^{RIV} may be the slot t₁^{CR}, or the slot tₛₜₐᵣₜ^{W}^{_{RESPONSE}}^{^{CO}} or the slot t_{end}^{W}^{_{RESPONSE}}^{^{CO}}, or the slot tₛₜₐᵣₜ^{W}^{_{RESOURCE}}^{^{CO}}, or the slot tₛₜₐᵣₜ^{W}^{_{RESOURCE}}^{^{CO}}.

Optionally, in Embodiment 1 of the present invention, “included in a MAC CE” may be replaced with “transmitted by using a MAC CE”.

Optionally, in Embodiment 1 of the present invention, “included in SCI” may be replaced with “transmitted by using SCI”.

Optionally, in Embodiment 1 of the present invention, “resource reservation period” may be replaced with “resource reservation interval”.

Optionally, in Embodiment 1 of the present invention, for m∈{1, . . . , M}, items in RICₘ may be arranged in any manner. For example, (TRIVₘ, FRIVₘ) may be replaced with (FRIVₘ, TRIVₘ). As another example, (TRIVₘ,FRIVₘ,tₘ^{RIV,ref}) may be replaced with (tₘ^{ref},TRIVₘ,FRIVₘ).

Optionally, in Embodiment 1 of the present invention, the resource pools u_{CR}, u_{CI}, and u_{RES}^{CO} are the same resource pool.

Optionally, in Embodiment 1 of the present invention, the number N_{subchannel}^{SL,u} of sub-channels of a resource pool u may be configured or pre-configured by a higher-layer parameter sl-NumSubchannel of the resource pool u.

Optionally, in Embodiment 1 of the present invention, the number N_{rsv_period}^{SL,u} of resource reservation periods of a resource pool u may be equal to the number of resource reservation periods configured or pre-configured by a higher-layer parameter sl-ResourceReservePeriodList of the resource pool u.

Optionally, in Embodiment 1 of the present invention, “coordination information” may be replaced with “coordination resource set” where applicable.

Optionally, in Embodiment 1 of the present invention, the first SCI format and the third SCI format may be the same SCI format (e.g., referred to as a “first coordination SCI format”).

Optionally, the first coordination SCI format includes an “SCI format identifier” field (e.g., the SCI format identifier field may be the first field in the first coordination SCI format). If the SCI format identifier field indicates that the first coordination SCI format is used for a coordination request, then the remaining fields of the first coordination SCI format are used to indicate the first coordination request. If the SCI format identifier field indicates that the first coordination SCI format is used for coordination information, then the remaining fields of the first coordination SCI format are used to indicate the first coordination information.

Optionally, in Embodiment 1 of the present invention, to determine the size of the first coordination SCI format, one or more padding operations in the following are performed:
If N_{SCI,1}^{CO,REQUEST}<N_{SCI,1}^{CO,INFO}, then the first coordination SCI format used for a coordination request is padded with bits ‘0’ until the size of a payload of the first coordination SCI format used for the coordination request is equal to N_{SCI,1}^{CO,INFO}.
If N_{SCI,1}^{CO,INFO}<N_{SCI,1}^{CO,REQUEST}, then the first coordination SCI format used for coordination information is padded with bits ‘0’ until the size of a payload of the first coordination SCI format used for the coordination information is equal to N_{SCI,1}^{CO,REQUEST}.
If N_{SCI,1}^{CO,REQUEST}<N_{SCI,1}^{CO}, then the first coordination SCI format used for a coordination request is padded with bits ‘0’ until the size of a payload of the first coordination SCI format used for the coordination request is equal to N_{SCI,1}^{CO}.
If N_{SCI,1}^{CO,INFO}<N_{SCI,1}^{CO}, then the first coordination SCI format used for coordination information is padded with bits ‘0’ until the size of a payload of the first coordination SCI format used for the coordination information is equal to N_{SCI,1}^{CO}.

N_{SCI,1}^{CO,REQUEST} and N_{SCI,1}^{CO,INFO} are respectively the sizes of information bits (or, payloads) of the first coordination SCI format used for a coordination request and the first coordination SCI format used for coordination information, and N_{SCI,1}^{CO} may be a predefined or configured or pre-configured value, or may be determined by one or more predefined or configured or pre-configured parameters.

Optionally, in Embodiment 1 of the present invention, the second SCI format and the fourth SCI format may be the same SCI format (e.g., referred to as a “second coordination SCI format”, and specifically, e.g., SCI format 2-C). Optionally, the second coordination SCI format includes an “SCI format identifier” field (e.g., the SCI format identifier field may be the first field in the second coordination SCI format). If the SCI format identifier field indicates that the second coordination SCI format is used for a coordination request, then the remaining fields of the second coordination SCI format are used to indicate the first coordination request. If the SCI format identifier field indicates that the second coordination SCI format is used for coordination information, then the remaining fields of the second coordination SCI format are used to indicate the first coordination information.

Optionally, in Embodiment 1 of the present invention, to determine the size of the second coordination SCI format, one or more padding operations in the following are performed:
If N_{SCI,2}^{CO,REQUEST}<N_{SCI,2}^{CO,INFO}, then the second coordination SCI format used for a coordination request is padded with bits ‘0’ until the size of a payload of the second coordination SCI format used for the coordination request is equal to N_{SCI,2}^{CO,INFO}.
If N_{SCI,2}^{CO,INFO}<N_{SCI,2}^{CO,REQUEST}, then the second coordination SCI format used for coordination information is padded with bits ‘0’ until the size of a payload of the second coordination SCI format used for the coordination information is equal to N_{SCI,2}^{CO,REQUEST}.
If N_{SCI,2}^{CO,REQUEST}<N_{SCI,2}^{CO}, then the second coordination SCI format used for a coordination request is padded with bits ‘0’ until the size of a payload of the second coordination SCI format used for the coordination request is equal to N_{SCI,2}^{CO}.
If N_{SCI,2}^{CO,INFO}<N_{SCI,2}^{CO}, then the second coordination SCI format used for coordination information is padded with bits ‘0’ until the size of a payload of the second coordination SCI format used for the coordination information is equal to N_{SCI,2}^{CO}.

N_{SCI,1}^{CO,REQUEST} and N_{SCI,1}^{CO,INFO} are respectively the sizes of information bits (or, payloads) of the second coordination SCI format used for a coordination request and the second coordination SCI format used for coordination information, and N_{SCI,1}^{CO} may be a predefined or configured or pre-configured value, or may be determined by one or more predefined or configured or pre-configured parameters.

Optionally, in Embodiment 1 of the present invention, T_{proc,1}^{CO} may be a predefined or configured or pre-configured value, or may be determined by one or more predefined or configured or pre-configured parameters.

Optionally, in Embodiment 1 of the present invention, T_{proc,2}^{CO} may be a predefined or configured or pre-configured value, or may be determined by one or more predefined or configured or pre-configured parameters.

Optionally, in Embodiment 1 of the present invention, T_{proc,3}^{CO} may be a predefined or configured or pre-configured value, or may be determined by one or more predefined or configured or pre-configured parameters.

Optionally, in Embodiment 1 of the present invention, any one among T_{proc,1}^{CO}, T_{proc,2}^{CO} and T_{proc,3}^{CO} may be equal to any one of the following:
0.
T_{proc,0}^{SL}.
T_{proc,0}^{SL}+1.
T_{proc,0}^{SL}−1.
T_{proc,1}^{SL}.
T_{proc,1}^{SL}+1.
T_{proc,1}^{SL}−1.
max(T_{proc,0}^{SL},T_{proc,1}^{SL}).
min(T_{proc,0}^{SL},T_{proc,1}^{SL}).
T_{proc,0}^{SL}+T_{proc,1}^{SL}.
T_{proc,0}^{SL}+T_{proc,1}^{SL}+1.
T_{proc,0}^{SL}+T_{proc,1}^{SL}−1.
T_{proc,0}^{SL}−T_{proc,1}^{SL}.
   |T_{proc,0}^{SL}−T_{proc,1}^{SL}|.
T_{proc,1}^{SL}−T_{proc,0}^{SL}.
   |T_{proc,1}^{SL}−T_{proc,0}^{SL}|.
   wherein
T_{proc,0} may be a predefined or configured or pre-configured value, or may be determined by one or more predefined or configured or pre-configured parameters. T_{proc,0} may be related to μ. For example, if μ=0, then T_{proc,0}=1. As another example, if μ=1, then T_{proc,0}=1. As another example, if μ=2, then T_{proc,0}=2. As another example, if μ=3, then T_{proc,0}=4.
T_{proc,1} may be a predefined or configured or pre-configured value, or may be determined by one or more predefined or configured or pre-configured parameters.

T_{proc,1} may be related to μ. For example, if μ=0, then T_{proc,1}=3. As another example, if μ=1, then T_{proc,1}=5. As another example, if μ=2, then T_{proc,1}=9. As another example, if μ=3, then T_{proc,1}=17.

In this way, according to the description of Embodiment 1, provided in the present invention is a method, in which MAC CE field types corresponding to resource indication combinations of different lengths are determined for different resource pool size ranges, thereby effectively reducing overhead of indicating a coordination resource set indication in a MAC CE, and enabling transmission of inter-UE coordination information to be efficiently completed. In addition, the value of the “first resource location” is flexibly indicated, so that a resource in any slot in a corresponding coordination resource window can be efficiently indicated in a resource indication combination.

In the present invention, “inter-UE coordination” and other related terms (e.g., “coordination information”, “coordination request”, “preferred resource”, “non-preferred resource”, “sidelink coordination control information”, “physical sidelink coordination information channel/signal”, “physical sidelink coordination request channel/signal”, and “coordination resource set” field, etc.) may be defined by functions thereof in a system and/or a corresponding procedure and/or corresponding signaling. When applied to a specific system, the terms may be replaced with other names.

### Variant Embodiment

Hereinafter, FIG. 9 is used to illustrate user equipment that can perform the method performed by user equipment described in detail above in the present invention as a variant embodiment.

FIG. 9 shows a block diagram of user equipment (UE) according to the present invention.

As shown in FIG. 9, the user equipment (UE) 90 includes a processor 901 and a memory 902. The processor 901 may include, for example, a microprocessor, a microcontroller, an embedded processor, and the like. The memory 902 may include, for example, a volatile memory (such as a random access memory (RAM)), a hard disk drive (HDD), a non-volatile memory (such as a flash memory), or other memories. etc. The memory 902 has program instructions stored thereon. The instructions, when run by the processor 901, may perform the method performed by user equipment as described above in detail in the present invention.

The method and related equipment according to the present invention have been described above in combination with preferred embodiments. It should be understood by those skilled in the art that the method shown above is only exemplary, and the above embodiments can be combined with one another as long as no contradiction arises. The method of the present invention is not limited to the steps or sequences illustrated above. The network node and user equipment shown above may include more modules, for example, modules that may be developed or developed in the future and that may be used for a base station, an Access and Mobility Management Function (AMF), a User Plane Function (UPF), a Mobility Management Entity (MME), a Serving Gateway (S-GW), or UE. Various identifiers shown above are only exemplary, and are not meant for limiting the present invention. The present invention is not limited to specific information elements serving as examples of these identifiers. A person skilled in the art could make various alterations and modifications according to the teachings of the illustrated embodiments. Those skilled in the art should understand that part or all of the mathematical expressions, mathematical equations, or mathematical inequations may be simplified or transformed or rewritten to some extent, for example, incorporating constant terms, or interchanging two addition terms, or interchanging two multiplication terms, or moving a term from the left side of an equation or inequation to the right side after changing the plus or minus sign thereof, or moving a term from the right side of an equation or inequation to the left side after changing the plus or minus sign thereof or the like. Mathematical expressions, mathematical equations, or mathematical inequations before and after the simplification or transformation or rewriting may be considered to be equivalent to each other.

It should be understood that the above-described embodiments of the present invention may be implemented by software, hardware, or a combination of software and hardware. For example, various components in the base station and user equipment in the above embodiments can be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present invention, the term “base station” may refer to a mobile communication data and/or control switching center having specific transmission power and a specific coverage area, and, for example, has functions such as resource allocation and scheduling, and data reception and transmission. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (the method) described in the embodiments of the present invention. Such setting of the present invention is typically provided as software, codes and/or other data structures provided or encoded on the computer-readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in the present description may include general-purpose processors, digital signal processors (DSPs), application-specific integrated circuits (ASICs) or general-purpose integrated circuits, field-programmable gate arrays (FPGAs) or other programmable logic devices, discrete gates or transistor logic, or discrete hardware components, or any combination of the above devices. The general-purpose processor may be a microprocessor, or the processor may be an existing processor, a controller, a microcontroller, or a state machine. The aforementioned general-purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-2. (canceled)

3. A user equipment (UE), comprising:
a processor; and
a memory, having instructions stored therein,
wherein the instructions, when run by the processor, perform:
determining contents of sidelink control information (SCI) format 2-C, wherein:
candidate values of a field in the SCI format 2-C include a first value and a second value;
the first value indicates that the SCI format 2-C is used for conveying inter-UE coordination information; and
the second value indicates that the SCI format 2-C is used for conveying a request for inter-UE coordination information, and
transmitting the SCI format 2-C.

4. A user equipment (UE), comprising:
a processor; and
a memory, having instructions stored therein,
wherein the instructions, when run by the processor, perform:
receiving sidelink control information (SCI) format 2-C, wherein:
candidate values of a field in the SCI format 2-C include a first value and a second value;
the first value indicates that the SCI format 2-C is used for conveying inter-UE coordination information; and
the second value indicates that the SCI format 2-C is used for conveying a request for inter-UE coordination information.

5. A method performed by user equipment (UE), the method comprising:
determining contents of sidelink control information (SCI) format 2-C, wherein:
candidate values of a field in the SCI format 2-C include a first value and a second value;
the first value indicates that the SCI format 2-C is used for conveying inter-UE coordination information; and
the second value indicates that the SCI format 2-C is used for conveying a request for inter-UE coordination information, and
transmitting the SCI format 2-C.
